(19) United States
(12) Patent Application Publication
(10) Pub. No.: US 2026/0288797 A1
(43) Pub. Date: Sep. 24, 2026

(54) SYSTEM

(71) Applicant: SoftBank Group Corp., Tokyo (JP)

(72) Inventor: Shingo HOMMA, Tokyo (JP)

(73) Assignee: SoftBank Group Corp., Tokyo (JP)

(21) Appl. No.: 19/557,198

(22) Filed: Mar. 5, 2026

(30) Foreign Application Priority Data
Mar. 19, 2025 (JP) 2025-044469

(51) Int. Cl. G06F 16/3329; G06Q 10/02

(52) U.S. Cl. CPC G06F 16/33295; G06Q 10/02

(57) ABSTRACT

A system includes a processor that is configured to create a first prompt sentence that instructs a generative AI model to obtain identification information of a user and to generate travel conditions based on the identification information, input the first prompt sentence into the generative AI model so that the generative AI model automatically generates the travel conditions, and create a second prompt sentence that instructs the generative AI model to provide the generated travel conditions to an interactive program and to start an interaction with the user.

### CROSS-REFERENCE TO RELATED APPLICATION

This application is based on and claims priority under 35 USC 119 from Japanese Patent Application No. 2025-044469 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventionally, when a user reserves or plans a trip through an online system, travel conditions such as destination, schedule, accommodation, and user preferences are either manually defined by the user or manually encoded by a system operator. As a result, it is difficult to promptly and accurately generate comprehensive travel conditions that reflect the user's identification information and travel information in a consistent manner. Furthermore, in conventional systems, an interactive program such as a chatbot is often not tightly integrated with the underlying travel conditions, so that answers to user inquiries are not sufficiently tailored to the specific trip of the user. In addition, when the user's travel information is updated over time, it is cumbersome to update the corresponding travel conditions and to align the responses of the generative AI model with the updated information. Therefore, there is a need for a system that automatically generates, updates, and utilizes travel conditions using a generative AI model, and that enables an interactive program to provide appropriate responses based on the generated travel conditions without requiring extensive manual configuration.

### SUMMARY

To solve the above-described problems, the invention provides a system comprising a processor. The processor is configured to create a first prompt sentence that instructs a generative AI model to obtain identification information of a user and to generate travel conditions based on the identification information, and to input the first prompt sentence into the generative AI model so that the generative AI model automatically generates the travel conditions. The processor is further configured to create a second prompt sentence that instructs the generative AI model to provide the generated travel conditions to an interactive program and to start an interaction with the user. In addition, the processor is configured, according to one embodiment, to create a third prompt sentence that instructs the generative AI model to provide, to an inquiry from the user, an appropriate response based on the generated travel conditions, and to input the third prompt sentence into the generative AI model. Furthermore, the processor is configured, according to another embodiment, to create a fourth prompt sentence that instructs the generative AI model to store travel information of the user in a database and to execute a condition generation algorithm to update the travel conditions. By these means, the system enables automatic generation and updating of travel conditions and enables an interactive program to provide trip-specific responses utilizing the capabilities of the generative AI model.

The term “system” refers to a combination of hardware and software components including at least one processor and associated memory, storage, and communication interfaces, which are configured to execute the processing defined in the claims.

The term “processor” refers to a hardware processing unit, such as a central processing unit (CPU), a graphics processing unit (GPU), a digital signal processor (DSP), an application specific integrated circuit (ASIC), a field programmable gate array (FPGA), or any combination thereof, which executes instructions to perform the functions specified in the claims.

The term “user” refers to a person who interacts, directly or indirectly through a terminal device, with the system for the purpose of reservation, planning, or inquiry regarding travel.

The term “identification information of a user” refers to information that uniquely or semi-uniquely identifies the user within the system, including but not limited to a user ID, login account, email address, or other identifiers associated with the user.

The term “travel conditions” refers to information representing constraints, parameters, or context related to a user's trip, including at least one of destination, travel dates, accommodation information, and user-related conditions, and which is used as a basis for generating responses to the user.

The term “prompt sentence” refers to a text string or equivalent data structure that is provided as input to a generative AI model, and that instructs the generative AI model to perform a specific operation, such as obtaining information, generating travel conditions, providing travel conditions to another program, or generating a response.

The term “generative AI model” refers to a machine-learned model configured to generate text or other content in response to input data, including but not limited to large language models and other neural network-based models that output natural-language sentences based on a prompt sentence.

The term “interactive program” refers to software that conducts a dialog or exchange of messages with the user, such as a chatbot, virtual assistant, or conversational user interface, and that outputs responses to the user based on the travel conditions generated by the generative AI model.

The term “inquiry from the user” refers to a question, request, or instruction expressed by the user, typically in natural language, and input to the system through a terminal or communication interface.

The term “appropriate response” refers to an answer or guidance generated for the user that is relevant to the user's inquiry and is tailored based on the generated travel conditions.

The term “travel information of the user” refers to information related to a specific or planned trip of the user, including at least one of destination, itinerary, accommodation details, transportation details, and other data associated with the user's travel.

The term “database” refers to any logical or physical data storage system, including relational databases, key-value stores, document stores, or other structured or semi-structured storage, which is used to store travel information and related data.

The term “condition generation algorithm” refers to a procedure or set of rules executed by or under the control of the processor, which processes travel information and related data to generate or update the travel conditions used by the generative AI model and the interactive program.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

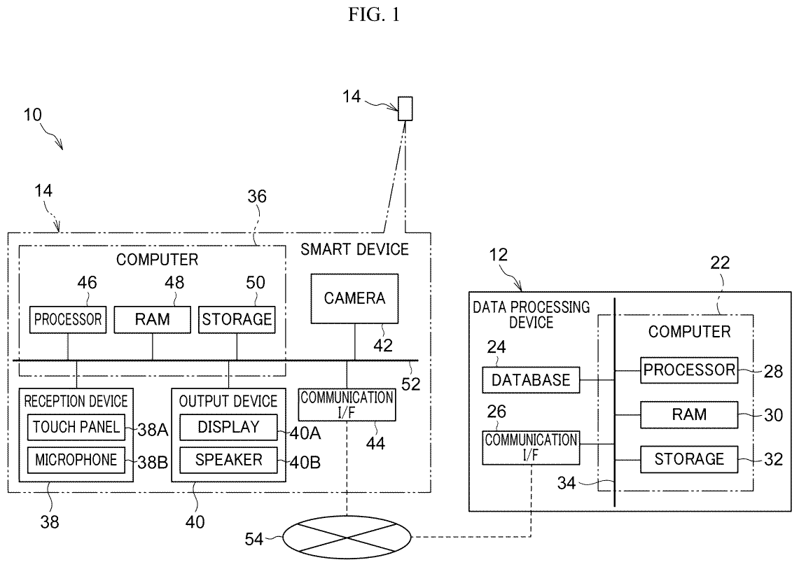

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

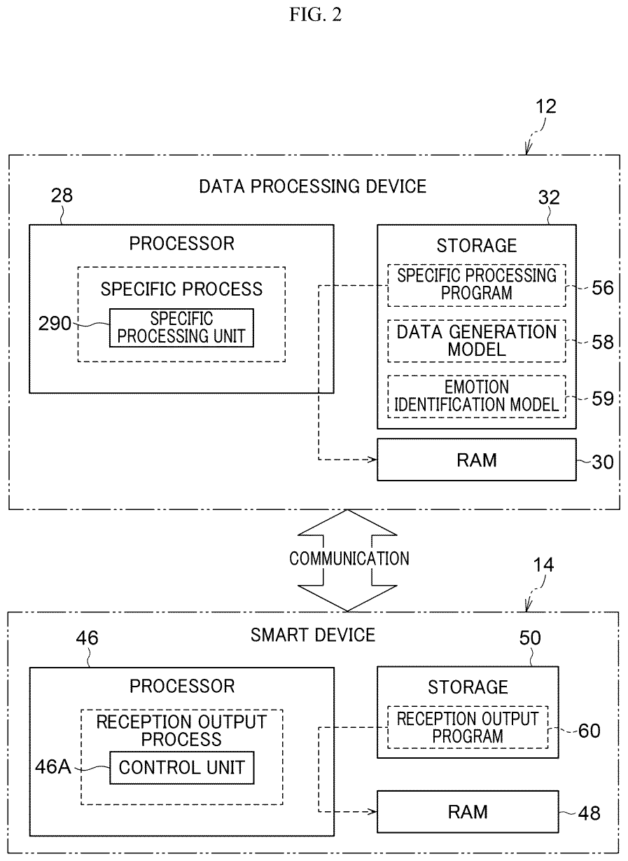

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional travel support systems that provide dialog-based assistance typically rely on static rule engines or fixed templates manually authored by developers. In such systems, the server-side logic simply retrieves stored reservation data and inserts portions of that data into pre-defined response patterns. As a result, the server is not capable of dynamically generating or updating travel conditions with sufficient granularity or context-awareness, and the dialog system cannot fully exploit generative AI models to produce high-quality, personalized responses grounded in the user's actual reservation data.

Moreover, in many existing architectures, a generative AI model is invoked in an ad hoc manner: the server sends a loosely structured prompt that mixes user questions and raw reservation data, without a systematic process for (i) transforming reservation data into structured travel conditions, (ii) converting those structured conditions into optimized prompt sentences, or (iii) iteratively updating both the conditions and the prompts over the course of a multi-turn dialog. This leads to inconsistent behavior of the generative AI model, increased hallucinations, and responses that may contradict stored reservation information.

From a computer technology perspective, the server's utilization of storage, processing, and external AI resources is suboptimal. The server does not maintain a clear separation between machine-oriented structured data and model-oriented natural language context. The server also lacks mechanisms for automatically optimizing prompt formats and control parameters based on accumulated user interaction history and condition information. Consequently, system resources are used inefficiently, and the dialog quality is highly dependent on manual prompt engineering rather than on systematic, machine-driven adaptation.

There is therefore a need for a system in which the server itself is configured to (1) acquire and structurally organize user identification and travel information, (2) generate and update travel condition data objects, (3) systematically convert those data objects into prompt sentences for both generative and interactive information processing apparatuses, and (4) automatically refine prompt structures and parameters based on stored interaction history. Such a configuration would improve the operation of the computer system as a whole by providing a more reliable, efficient, and consistent pipeline between stored travel data, condition generation processing, and generative AI-based dialog processing.

The specific processing by the specific processing unit 290 of the data processing device 12 in Example 1 is realized by the following means.

The present invention provides a server comprising a processor and a storage device, the processor being configured to acquire identification information and travel information of a user from a user terminal, store the travel information in the storage device in association with the identification information, generate structured information representing travel conditions on the basis of destination information, schedule information, and accommodation information included in the travel information, generate, using the structured information as input, a condition sentence that describes contents of the structured information in natural language and a prompt sentence that instructs a generative information processing apparatus to generate, supplement, or update the travel conditions on the basis of the condition sentence, input the prompt sentence into the generative information processing apparatus to automatically supplement or update the travel conditions and thereby generate condition information including supplemented or updated travel conditions, generate, using the condition information as input, context information that describes the condition information in natural language and a prompt sentence that instructs an interactive information processing apparatus to perform conversation processing on the basis of the context information, input the condition information together with the prompt sentence into the interactive information processing apparatus so as to start or continue a dialog with the user, and further acquire inquiry information transmitted from the user terminal, associate the inquiry information with the condition information, transmit the inquiry information and the condition information to the interactive information processing apparatus, and control output of response information, which is acquired from the interactive information processing apparatus, to the user terminal. This enables the computer system to perform an integrated sequence of operations in which stored travel data are transformed into structured travel conditions, those conditions are converted into optimized prompt sentences for a generative AI model and an interactive dialog engine, and both the travel conditions and the prompt structures are automatically updated based on user interactions, thereby improving the consistency, efficiency, and reliability of generative AI-based travel support on the server.

The term “processor” refers to a hardware or virtual computation unit, such as a central processing unit or a computing core, that executes instructions of a program to perform data acquisition, data processing, control, and communication operations in the system.

The term “storage device” refers to a hardware or virtual storage resource, such as a main memory, a nonvolatile memory, or an external storage system, that stores travel information, identification information, condition information, inquiry history information, and programs used by the processor.

The term “identification information” refers to information that allows a user to be distinguished from other users in the system, including, for example, an account identifier, a session identifier, or an authentication token.

The term “travel information” refers to information related to a user's planned or reserved travel, including destination information, schedule information, accommodation information, and other parameters required to characterize the travel.

The term “destination information” refers to information indicating one or more locations for a user's travel, including, for example, a country, a region, a city, or a facility category associated with the travel.

The term “schedule information” refers to information indicating a temporal aspect of a user's travel, including, for example, a departure date, a return date, a stay duration, and time-related constraints associated with the travel.

The term “accommodation information” refers to information indicating lodging related to a user's travel, including, for example, a lodging facility name, a lodging area, a check-in time, a check-out time, and lodging conditions.

The term “structured information” refers to information that represents travel conditions or related data in a machine-processable format, such as a record, a table, or a hierarchical data structure, where elements are explicitly associated with keys or fields.

The term “travel conditions” refers to conditions derived from or associated with a user's travel information, including, for example, recommended points of interest, temporal constraints, lodging conditions, and other parameters used to generate responses related to the travel.

The term “condition information” refers to information including one or more travel conditions, optionally supplemented or updated by processing performed by a generative information processing apparatus, and stored or used as a basis for dialog processing.

The term “condition sentence” refers to a natural language expression generated from structured information, describing contents of the structured information so that a generative information processing apparatus can interpret the structured information.

The term “context information” refers to a natural language expression generated from condition information, describing a state or background of a user's travel and being provided to an interactive information processing apparatus for use in conversation processing.

The term “prompt sentence” refers to a natural language instruction or a set of natural language instructions input to a generative information processing apparatus or an interactive information processing apparatus, the instruction specifying a processing task, a role, or a constraint for the apparatus.

The term “generative information processing apparatus” refers to a hardware or software system, including a generative AI model, that receives at least one prompt sentence and optionally additional data, and outputs generated information such as supplemented or updated travel conditions or response candidate sentences.

The term “interactive information processing apparatus” refers to a hardware or software system, including a dialog engine or a natural language interaction module, that receives context information, prompt sentences, and inquiry information, and outputs response information suitable for dialog with a user.

The term “generative AI model” refers to a statistical or machine learning model configured to receive a prompt sentence as input and to generate, based on learned parameters, natural language output or structured output, including travel condition updates or response texts.

The term “user terminal” refers to an information processing device operated by a user, such as a communication terminal or a computing device, that transmits identification information, travel information, and inquiry information to the server and receives response information from the server.

The term “inquiry information” refers to information that represents a question, a request, or an instruction provided by a user through a user terminal, typically expressed in natural language, regarding travel conditions or related topics.

The term “inquiry history information” refers to information indicating one or more past inquiries from a user and associated response information or processing results, stored so that subsequent processing can utilize accumulated interaction context.

The term “response information” refers to information generated by an interactive information processing apparatus in response to inquiry information and condition information, including, for example, natural language answers, recommendations, or explanations.

The term “response candidate sentence” refers to a natural language expression generated by a generative information processing apparatus as a candidate for response information, the expression reflecting travel conditions and additional travel conditions.

The term “additional travel conditions” refers to travel-related conditions that are newly derived or refined by the generative information processing apparatus on the basis of condition information and inquiry history information, for use in updating the condition information.

The term “condition generation processing” refers to processing performed by the processor or another computation unit to generate or update travel conditions from travel information, structured information, or condition information, including extraction, transformation, aggregation, and selection operations.

The term “control parameter” refers to a value or a set of values used to control behavior of a generative information processing apparatus or an interactive information processing apparatus, including, for example, a temperature value, a maximum output length, or a style constraint.

The term “optimization processing” refers to processing that adjusts, based on condition information and inquiry history information, at least one of the contents of condition generation processing and formats or control parameters of prompt sentences, so as to improve consistency, efficiency, or quality of generated outputs.

In one embodiment, a server cooperates with one or more terminals operated by users to provide travel support using structured condition information and a generative AI model. The server includes at least one processor, a main memory, a nonvolatile storage device, a communication interface, and a database system. The server executes an operating system such as a general-purpose server operating system, a web application framework such as a Python-based framework or a JavaScript-based framework, and a database management system such as a relational database system.

The server stores travel information and identification information in the relational database system. The server uses a database driver library to execute structured query language statements for inserting, updating, and retrieving records. The database stores tables such as a user table, a reservation table, a travel condition table, and an inquiry history table. The reservation table includes fields such as user identifier, destination code, check-in date, check-out date, and accommodation identifier. The travel condition table includes fields such as user identifier, structured condition object, generation time, and version number. The server represents the structured condition object in a machine-readable format such as a hierarchical key-value structure where keys such as destination, period, accommodation, and recommended_spots are associated with corresponding values.

The server generates and manages travel conditions in a multi-stage data processing pipeline. The server first transforms raw travel information into structured information by normalizing destination codes, converting date strings into internal date-time representations, and resolving accommodation identifiers into canonical accommodation records. The server then applies a condition generation algorithm that operates on the structured information and auxiliary data sources such as a table of points of interest, a table of transportation options, and a table of time constraints. The server uses algorithmic operations including filtering by geographic region, ranking using weighted scores, and aggregating attributes across multiple records. For example, the server computes a score for each point of interest using a weighted sum of factors such as popularity, distance from accommodation, and category match to a preferred activity type.

The server converts the resulting structured condition object into a condition sentence in natural language. The server uses rule-based templates and token-level replacement to describe key fields of the structured condition object. For example, the server generates a condition sentence such as:

“The user has booked a trip to Tokyo, from 2023 Dec. 1 to 2023 Dec. 3, and will stay at a hotel in the Shinjuku area. Recommended sightseeing spots currently include Senso-ji Temple and Tokyo Skytree. The hotel check-in time is 15:00.”

The server then generates a prompt sentence directed to a generative AI model. The server uses a fixed or adaptable prompt schema where distinct segments define a role instruction, a context description, and an output requirement. An example prompt sentence generated by the server is:

“You are a travel assistant. Based on the following travel conditions, supplement or refine recommended sightseeing spots and any important constraints: The user has booked a trip to Tokyo, from 2023 Dec. 1 to 2023 Dec. 3, and will stay at a hotel in the Shinjuku area. Recommended sightseeing spots currently include Senso-ji Temple and Tokyo Skytree. The hotel check-in time is 15:00. Provide updated travel conditions in concise natural language.”

The server transmits this prompt sentence to a generative information processing apparatus that implements a generative AI model. In one embodiment, the generative AI model is a transformer-based neural network trained on large-scale text data. The model includes an embedding layer, a plurality of self-attention layers, feed-forward networks, and an output projection layer. The server sends tokenized input sequences to the model via an application programming interface exposed by the generative information processing apparatus. The generative information processing apparatus executes the model on acceleration hardware such as graphics processing units or tensor processing units.

The server configures the generative AI model with control parameters such as a temperature parameter for sampling distribution, a maximum output length parameter, and a top-k or top-p sampling parameter. By explicitly setting these control parameters in the prompt-level or API-level configuration, the server controls variability, determinism, and resource consumption of the model's output. The server receives the model-generated text and parses it according to a predefined parsing rule. For example, the server uses delimiter tokens or key phrases in the output to identify segments corresponding to additional travel conditions or updated lists of recommended spots.

The server updates the condition information by merging the model-generated conditions with existing structured information. The server performs deterministic merging rules such as preferring higher-scoring recommendations, removing duplicates, and attaching confidence values. The server then stores the updated condition information in the travel condition table, associating each version with a timestamp and a generation source. This multi-stage structural transformation and merging process improves internal data consistency, reduces reliance on ad hoc model outputs, and enables repeatable behavior across sessions.

The server also generates context information and a second category of prompt sentence for an interactive information processing apparatus. The server converts the condition information into a context sentence that emphasizes user-relevant aspects and constraints. An example of such a context sentence is:

“The user has an upcoming three-day stay in Tokyo, with lodging in the Shinjuku district. The user may wish to visit major landmarks such as Senso-ji Temple and Tokyo Skytree, and must consider a hotel check-in time of 15:00 and a check-out time of 11:00.”

The server then generates a prompt sentence that defines how the interactive information processing apparatus should conduct conversation. An example is:

“You are an interactive travel assistant. Use the following context to answer the user's questions accurately and concisely: [context sentence]. Always ensure that your answers are consistent with the dates, accommodation, and recommended spots described above.”

The server sends the context information and prompt sentence to the interactive information processing apparatus, which may be implemented by a dialog management engine combined with a generative AI model or other natural language processing modules. The server maintains a clear separation between machine-oriented structured condition information and natural-language context, and explicitly serializes context segments for each dialog session. This separation and explicit serialization reduce ambiguity in model inputs, lower the risk of hallucinated information, and increase reproducibility of responses.

The terminal provides a user interface for inputting reservation data and natural language inquiries. The terminal executes a web browser or a native application. The terminal renders forms for entering destination, dates, and accommodation data, and transmits the entered data to the server via a secure communication channel. The terminal displays chat-style interaction when the user asks questions such as:

“What sightseeing spots do you recommend in Tokyo?”

“What time can I check in to my hotel?”

“How long does it take to travel from my hotel in Shinjuku to Tokyo Skytree by train?”

The server receives each inquiry and associates it with stored condition information and inquiry history information. The server records each inquiry and any corresponding response into the inquiry history table. The server uses this inquiry history information when generating subsequent prompt sentences for the generative AI model. For example, the server may generate a prompt sentence such as:

“The user previously asked about recommended sightseeing spots in Tokyo and received recommendations including Senso-ji Temple and Tokyo Skytree. Now the user asks: ‘How long does it take to travel from my hotel in Shinjuku to Tokyo Skytree by train?’ Based on the existing travel conditions and prior recommendations, estimate a typical travel time window and indicate the main public transport options, without contradicting the existing conditions.”

By incorporating explicit references to past inquiries and responses, the server reduces the need for the generative AI model to infer context implicitly and thus lowers error rates in follow-up answers. The server's explicit crafting and management of prompt sentences and context information represent a non-conventional use of generative AI that improves technical performance, including accuracy, consistency across turns, and efficient reuse of existing condition information.

In another embodiment, the server adjusts formats and control parameters of prompt sentences over time. The server analyzes inquiry history information and associated response quality indicators, such as user feedback signals, internal consistency checks, or rule-based validation results. The server uses these results to refine prompt templates, for example by changing ordering of context segments, adding explicit constraints, or modifying temperature and output length parameters. The server formulates an optimization prompt sentence describing the desired change to prompt structures and sends it to the generative AI model as meta-instruction. The generative AI model generates candidate modifications to prompt schemas; the server then applies deterministic selection criteria to choose modifications that satisfy internal validation rules. This iterative adjustment enables the server to optimize model behavior in a manner that would be difficult to achieve via static manual prompt engineering.

From the perspective of computer technology, the described system improves operation of the underlying computing environment. The server reduces communication load and processing time by reusing stored structured condition information rather than re-sending raw reservation data and full histories for each model invocation. Because the server maintains the condition information in a normalized, indexed form in the database, the server can retrieve and serialize only relevant subsets for each dialog turn, thereby reducing input size to the generative AI model and decreasing token-level computation. This directly leads to faster response times and lower hardware utilization per query.

The server also improves accuracy by constraining model behavior through structured context and explicit instructions. The server's condition generation algorithm, which includes deterministic filtering, ranking, and merging operations, ensures that high-confidence, database-verified travel attributes dominate the model's input context. The generative AI model is then used primarily to supplement and rephrase within those constraints, which reduces the likelihood of generating nonexistent hotels, impossible schedules, or contradictory recommendations. This hybrid design—structured algorithmic preprocessing followed by controlled generative supplementation—is different from a mere automation of human conversation and constitutes an improvement in computer-based text generation workflows.

The server further improves data management through versioning and traceability. Every update to condition information is stored with provenance metadata, including source (algorithmic vs. model-generated), timestamps, and applicable inquiry identifiers. This structure allows the server to roll back to prior condition states, compare different versions for debugging, and perform offline analysis to refine the condition generation algorithm. This capability is technical in nature and addresses issues of reproducibility, reliability, and maintainability in AI-supported systems.

In one variation, the generative AI model is trained with a supervised objective using pairs of prompt sentences and desired outputs, where the loss function is a cross-entropy loss over token sequences. The model parameters are updated using gradient-based optimization such as stochastic gradient descent or adaptive methods. The training corpus may be augmented with synthetic examples generated from the server's own condition data and generic travel knowledge so that the model is particularly sensitive to structured condition descriptions. The server can also apply data augmentation techniques, such as paraphrasing condition sentences using another model or rule set, to increase robustness to wording variations. These internal training details further emphasize that the model's behavior is engineered for compatibility with the server's structured condition pipeline.

In another implementation, the server uses a multi-head attention mechanism within the transformer architecture to focus on different segments of the prompt sentence. For example, separate attention heads may be biased toward the role instruction segment, the condition description segment, and the user question segment. The server can adjust attention-related control parameters or prompt formatting to enforce that key travel constraints receive higher relative attention. This non-conventional handling of transformer inputs improves the model's ability to respect database-derived facts, again distinguishing the system from simple human-task automation.

The terminal and server together implement a complete data flow from user input to AI-assisted response without relying on manual intervention. The server automatically transforms user input into structured data, applies a defined condition generation algorithm, orchestrates communication with generative and interactive information processing apparatuses, and manages the life cycle of condition and inquiry information. Because each of these stages is explicitly defined and implemented at the level of data structures and algorithms, a person skilled in the art can realize the invention using general-purpose computing hardware and software.

Alternative embodiments may vary specific components while preserving the same overall architecture. For example, the relational database system can be replaced with a document-oriented database storing condition objects as documents, while the server still maintains explicit schema fields within each document. The generative AI model can be replaced with another sequence-to-sequence model that uses recurrent layers rather than transformer layers, provided that the server continues to supply structured condition sentences and control parameters. The interactive information processing apparatus can be integrated into the same physical server or distributed across multiple servers connected via networks. The terminal can be a mobile device, a desktop computer, or a dedicated kiosk, as long as it is capable of sending and receiving textual information to and from the server.

By structuring data processing, prompt sentence generation, and model configuration in this manner, the server does more than simply automate human travel advice. The server implements a non-conventional computational pipeline optimized for interaction with generative AI models, leading to improved speed, accuracy, consistency, and resource utilization in the technical sense.

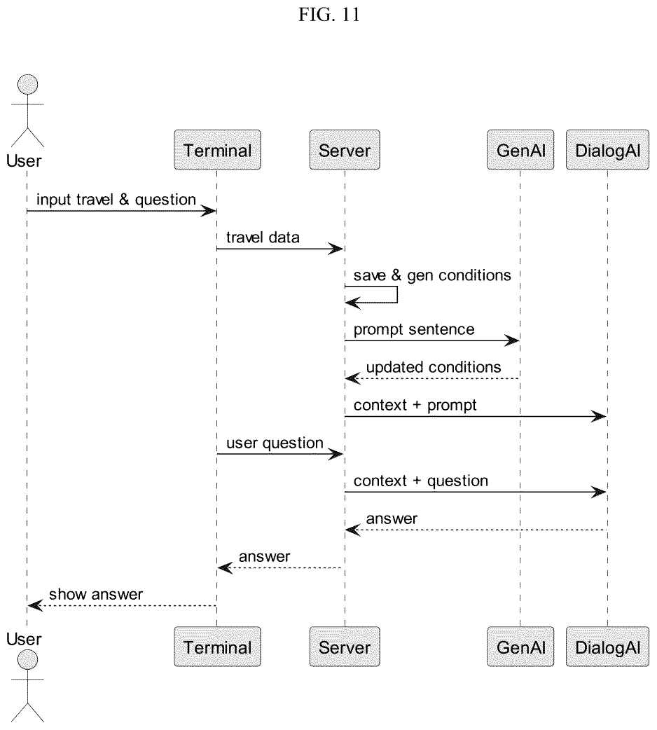

The following describes the processing flow using FIG. 11.

### Step 1

User operates the terminal to access a travel reservation interface and input travel information.

User enters destination, check-in date, check-out date, and accommodation information into input fields displayed on the terminal.

Terminal validates basic formats (for example, date formats and required fields) and constructs an internal data object containing identification information (such as a session identifier) and travel information.

Input: User keystrokes and selections on the terminal UI.

Output: A structured request object containing identification information and travel information, ready to be transmitted to the server.

### Step 2

Terminal transmits the structured request object to the server via a secure network connection.

Terminal serializes the identification information and travel information into a message format and sends an HTTP request to a specified endpoint of the server.

Input: The structured request object created in Step 1.

Output: A network message containing the identification information and travel information, delivered to the server.

### Step 3

Server receives the network message and performs authentication and parsing.

Server validates the identification information (for example, by checking a token against an authentication module) and parses destination, schedule, and accommodation fields from the received message.

Input: The network message containing identification information and travel information.

Output: Validated identification information and parsed travel information stored in server memory as internal data structures.

### Step 4

Server stores the parsed travel information in a database in association with the identification information.

Server constructs database insert or update commands and executes them via a database driver, thereby writing reservation records into a reservation table and linking them to a user record.

Input: Parsed travel information and identification information from Step 3.

Output: Persistent reservation records stored in the database, each associated with a user identifier.

### Step 5

Server retrieves stored travel information and auxiliary data needed for condition generation.

Server issues database queries to obtain the user's reservation record and related data such as points of interest, transportation options, and accommodation attributes from corresponding tables.

Input: User identifier and database state created in Step 4.

Output: A set of in-memory data structures representing the reservation details and related domain data.

### Step 6

Server executes a condition generation algorithm to create structured travel conditions.

Server performs data processing operations including filtering points of interest by region, computing a stay period from check-in and check-out dates, calculating distances or travel times relative to the accommodation, and ranking items using a scoring formula.

Input: The in-memory reservation data and auxiliary domain data from Step 5.

Output: Structured condition information represented as a condition object containing fields such as destination, stay duration, accommodation details, and ranked recommended spots.

### Step 7

Server converts the structured condition information into a condition sentence expressed in natural language.

Server applies template-based text generation rules, replacing placeholders with values from the condition object to describe the user's trip, the lodging location, and the recommended points of interest.

Input: The condition object generated in Step 6.

Output: A condition sentence in natural language summarizing the structured travel conditions.

### Step 8

Server generates a first prompt sentence for a generative AI model using the condition sentence as context.

Server combines a role instruction (for example, “You are a travel assistant”), the condition sentence, and explicit output requirements into one continuous prompt text optimized for model input.

Input: The condition sentence from Step 7 and predefined prompt templates.

Output: A first prompt sentence instructing the generative AI model how to supplement or update travel conditions.

### Step 9

Server transmits the first prompt sentence to a generative information processing apparatus that hosts the generative AI model.

Server tokenizes or passes the text directly according to an application programming interface specification and specifies model parameters such as maximum output length and temperature.

Input: The first prompt sentence created in Step 8.

Output: An API request containing the prompt sentence and model control parameters, sent to the generative information processing apparatus.

### Step 10

Server receives the model-generated text representing supplemented or updated travel conditions and integrates it with existing structured condition information.

Server parses the generated text using predefined delimiters or pattern-matching rules to extract new or modified travel conditions and merges them into the condition object, resolving conflicts by applying deterministic rules.

Input: The model-generated text received from the generative information processing apparatus and the existing condition object from Step 6.

Output: Updated condition information containing both original and supplemented travel conditions, stored as a revised condition object.

### Step 11

Server stores the updated condition information in the database for later retrieval and version tracking.

Server creates or updates an entry in a travel condition table, writing the updated condition object and associated metadata such as timestamp and version number.

Input: The updated condition object from Step 10 and the user identifier.

Output: Persistent condition records in the database, each representing a version of the user's travel conditions.

### Step 12

Server converts the updated condition information into context information for an interactive dialog.

Server selects portions of the condition object that are most relevant to user interaction, such as key dates, accommodation details, and prioritized recommendations, and generates a context sentence that describes these elements in natural language.

Input: The updated condition object stored in Step 11.

Output: A context sentence that provides conversational background for subsequent dialog processing.

### Step 13

Server generates a second prompt sentence for an interactive information processing apparatus using the context sentence.

Server creates an instruction segment defining the assistant's role and behavior (for example, answer accurately and concisely based on the context), appends the context sentence, and adds constraints such as not contradicting the described conditions.

Input: The context sentence from Step 12 and predefined dialog prompt templates.

Output: A second prompt sentence that instructs the interactive information processing apparatus how to conduct dialog with the user.

### Step 14

Terminal displays a dialog interface and sends user inquiries to the server.

Terminal shows a text input area and message history; when the user types a question and submits it, the terminal packages the question as inquiry information together with the current session identifier and transmits it to the server.

Input: User-typed question such as “What sightseeing spots do you recommend in Tokyo?” or “What time can I check in to my hotel?”.

Output: A network message containing inquiry information and identification information delivered to the server.

### Step 15

Server receives the inquiry information, associates it with condition information, and records it as inquiry history.

Server retrieves the current condition object for the user from the database, links the inquiry text to the condition version, and stores a new record in an inquiry history table.

Input: The network message from Step 14 and the condition records from Step 11.

Output: An updated inquiry history record and an in-memory combination of inquiry information and condition information for dialog processing.

### Step 16

Server constructs a combined dialog input consisting of the second prompt sentence, the context information, and the current inquiry.

Server concatenates or structurally organizes the second prompt sentence, the context sentence, and the user's question into a single text or multi-part message according to the interface specification of the interactive information processing apparatus.

Input: The second prompt sentence from Step 13, the context sentence from Step 12, and the inquiry information from Step 15.

Output: A dialog input message that clearly separates instructions, context, and user question for the interactive information processing apparatus.

### Step 17

Server transmits the dialog input message to the interactive information processing apparatus and requests response generation.

Server sends the combined message via an application programming interface, specifying any dialog-specific control parameters such as maximum response length or required language.

Input: The dialog input message from Step 16.

Output: An API request delivered to the interactive information processing apparatus to generate response information.

### Step 18

Server receives response information generated for the user's inquiry and performs optional post-processing.

Server checks the response for format compliance, replaces internal identifiers with user-friendly names, and may correct date or time formats to match the user's locale.

Input: The raw response text from the interactive information processing apparatus.

Output: A finalized response message ready to be sent to the terminal.

### Step 19

Terminal receives the finalized response message and updates the user interface to display the answer.

Terminal parses the received message, adds the answer text to the dialog history, and renders it as a new message bubble or text block visible to the user.

Input: The finalized response message from Step 18.

Output: A visual presentation of the response on the terminal's display and an updated local interaction state.

### Step 20

Server optionally refines prompt formats and control parameters based on accumulated inquiry history and response data.

Server analyzes stored inquiry history records and associated responses to detect patterns such as frequent clarifications or inconsistencies, then generates meta-level instructions that modify prompt templates or parameter values used in Steps 8 and 13.

Input: Inquiry history information, condition versions, and recorded responses from prior interactions.

Output: Updated prompt templates and control parameter settings that will be applied in subsequent executions of the generative AI model and dialog processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional travel-support systems generally rely on fixed rule engines and static templates for generating travel conditions and presenting information to users. In such systems, a processor typically maps user profile data and booking data into pre-defined fields, and then renders canned responses or fixed recommendation lists. As a result, the system's behavior is tightly constrained by hand-crafted rules and is not able to flexibly adapt to diverse user intents, changing external information such as local events or weather, or multi-step conversational context.

In addition, in conventional architectures, natural language processing is often applied only at the user interface layer to parse queries, while the core decision logic for condition generation, ranking, and response formatting remains purely deterministic. This separation leads to several technical problems. First, the processor cannot effectively integrate heterogeneous signals—such as user identification information, historic travel logs, external information from multiple providers, and multi-turn dialog context—into a unified, machine-interpretable representation of “travel conditions.” Second, the system struggles to generate coherent, context-aware responses that are consistent with the structured data actually available, leading to either underutilization of external data or inconsistent outputs. Third, the pipeline for updating travel conditions and recommendation policies over time is rigid; it requires manual redesign and redeployment when new data patterns emerge, which results in poor scalability and degraded user experience.

Furthermore, the naive integration of generative AI models into travel-support systems presents additional technical issues. If a generative AI model is called simply with raw user text, the model may produce hallucinated locations or events that do not correspond to actual external information. Without a structured prompt design and without tight coupling between the model's output and the system's internal data structures, the processor cannot enforce consistency between generated text and authoritative data sources. This leads to unreliable guidance, makes automated validation difficult, and increases the computational and network load due to redundant or ineffective calls to external information sources and generative AI services.

There is therefore a need for an improved computer-implemented architecture in which a processor uses prompt sentences as first-class control instructions to a generative AI model and to natural language processing components, so that internal condition generation, external data retrieval, information selection, and response generation are coordinated end-to-end. Specifically, there is a need for a system in which: (i) user identification information, travel-related information, and dialog history are converted into structured “travel condition data” under programmatic control; (ii) external information from multiple providers is filtered and ranked based on this travel condition data; (iii) generative AI models are driven by structured prompt sentences that embed both user context and machine-readable candidate information; and (iv) the resulting outputs are used to dynamically update travel conditions, weighting parameters, and information selection rules. By solving these problems, the invention aims to improve the operation of the computer system itself, enabling more efficient use of processing and communication resources, higher-quality context-aware responses, and a more robust and maintainable conversational pipeline.

The specific processing by the specific processing unit 290 of the data processing device 12 in Application Example 1 is realized by the following means.

The present invention provides a server comprising a processor configured to acquire user identification information and travel-related information from a terminal device, generate travel condition data by causing a generative AI model to execute a travel condition generation process in response to a prompt sentence created based on user attribute information, movement schedule information, stay information, and preference information, analyze context information including the travel condition data and inquiry text from a user by causing a natural language processing function or the generative AI model to execute an intent extraction process in response to a prompt sentence, generate search condition data for external information sources based on extracted intent information and the travel condition data, acquire external information data including facility information, weather information, and event information from an external information providing apparatus using the search condition data, select and evaluate candidate information data to be presented to the user by causing the generative AI model to execute a response generation process in response to a prompt sentence and the candidate information data so as to generate response text data including natural language description text and recommendation reason text, transmit the response text data and the candidate information data to the terminal device so as to perform dialog processing with the user, and store operation information, selection results, and history data, and dynamically update the travel condition data and recommendation policy data by causing the generative AI model to execute a condition update process in response to a prompt sentence based on the history data. This enables an integrated, prompt-driven control architecture in which the processor coordinates travel condition generation, external information retrieval, information selection, and natural language response generation through structured prompt sentences, thereby improving the efficiency, adaptability, and reliability of the computer-implemented travel-support system, reducing inconsistent or hallucinated outputs, and allowing the system to autonomously refine its internal models and selection rules over time based on accumulated interaction history.

The term “user identification information” refers to information that uniquely identifies a user in the system, including at least one of a user identifier, an authentication token, account profile data, or other attributes that enable association of interactions and travel data with a particular user.

The term “travel-related information” refers to information associated with a user's travel, including at least one of a destination, travel dates, transportation data, accommodation data, activity preferences, and budget constraints.

The term “travel condition data” refers to structured data representing conditions, constraints, and preferences for a user's travel, generated by processing user identification information, travel-related information, and optionally historical interaction data, and used as context for searching and selecting travel-related information.

The term “prompt sentence” refers to a machine-readable text string that is created by the processor and provided as input to a generative AI model or a natural language processing component, the text string specifying a processing task, context, constraints, or an output format to be executed by the model or component.

The term “generative AI model” refers to a machine-learned model configured to generate output data, including natural language text, in response to input data such as prompt sentences and structured context information.

The term “natural language processing function” refers to a processing capability, implemented by software, hardware, or a combination thereof, that analyzes natural language text to extract information such as entities, intents, relations, sentiment, or syntactic structure.

The term “external processing apparatus” refers to a computing resource separate from the server, including at least one of a cloud-based service, an application programming interface endpoint, or a remote computing node, which executes a natural language processing function or generative model processing in response to input from the server.

The term “inquiry text” refers to natural language text representing a question, request, or instruction provided by a user to the system through a terminal device.

The term “inquiry intent information” refers to structured data representing a purpose, goal, or requested action inferred from an inquiry text, including at least one of a requested information type, a time constraint, a location constraint, or a preference.

The term “related item information” refers to structured data identifying entities or topics associated with an inquiry text, including at least one of place names, event names, categories, or time expressions.

The term “search condition data” refers to structured data derived from inquiry intent information, related item information, and travel condition data, and used as parameters for querying external information sources, including at least one of location coordinates, time ranges, categories, and filter conditions.

The term “external information source” refers to any data provider outside the server, including at least one of a web service, a database service, or an information feed, from which travel-related information can be obtained in response to search condition data.

The term “external information providing apparatus” refers to a computing system that supplies external information data, through a communication interface, in response to queries containing search condition data.

The term “external information data” refers to data acquired from an external information source, including at least one of facility information, weather information, event information, transportation information, or geographic information.

The term “facility information” refers to data describing physical locations or service facilities relevant to travel, including at least one of names, categories, locations, operating hours, ratings, and contact information.

The term “weather information” refers to data representing meteorological conditions or forecasts, including at least one of temperature, precipitation, wind, and weather alerts, associated with specified locations and time ranges.

The term “event information” refers to data describing scheduled activities or happenings at a destination, including at least one of event names, venues, time schedules, categories, and ticketing information.

The term “candidate information data” refers to a subset of external information data that has been selected or generated as potential content to be presented to the user, prior to final formatting into natural language response text.

The term “selection and evaluation” refers to processing for filtering, ranking, and scoring candidate information data, based on travel condition data, user preferences, or system-defined rules, to determine which items are to be presented to the user.

The term “response text data” refers to natural language text generated by a generative AI model, formatted for presentation to the user, and including at least one of explanations of candidate information data, recommendations, and guidance for next user actions.

The term “natural language description text” refers to a part of response text data that provides explanatory content about candidate information data in human-readable natural language.

The term “recommendation reason text” refers to a part of response text data that explains, in natural language, why particular items in the candidate information data are recommended to the user, based on travel condition data, preferences, or other criteria.

The term “terminal device” refers to an end-user computing device, including at least one of a smartphone, a tablet, a personal computer, or a wearable device, configured to communicate with the server and to present information to the user.

The term “dialog processing” refers to a sequence of interactive exchanges between the server and the user through the terminal device, implemented as multi-turn communication that uses prior context to generate subsequent responses.

The term “operation information” refers to data representing user interactions with the terminal device or the system, including at least one of user selections, confirmations, modifications, or navigation actions.

The term “selection results” refers to data indicating which candidate information data items have been accepted, rejected, or otherwise acted upon by the user during dialog processing.

The term “log data” refers to stored records of operation information, selection results, system-generated responses, and processing parameters associated with user sessions.

The term “history data” refers to accumulated log data and associated travel condition data and external information data from past interactions, stored for later analysis and model updating.

The term “recommendation policy data” refers to structured data representing rules, weighting parameters, or strategies used by the system to select, filter, and rank information items for recommendation to the user.

The term “condition generation process” refers to a sequence of computations, performed by or under control of a generative AI model or other processing logic, that transforms user identification information and travel-related information into travel condition data.

The term “information selection process” refers to a sequence of computations that determine which external information data items are to be treated as candidate information data and in what order or priority they are to be presented.

The term “condition update process” refers to a sequence of computations, initiated by a prompt sentence and executed by a generative AI model or other processing logic, that uses history data to modify travel condition data, recommendation policy data, or associated parameters over time.

The term “response generation process” refers to a sequence of computations in which a generative AI model produces response text data, in natural language, from input including prompt sentences and candidate information data.

The term “weighting parameters” refers to numerical or symbolic values used to adjust the relative importance of different features, criteria, or data sources during selection, ranking, or condition generation in the system.

The term “information selection rules” refers to predefined or dynamically learned logical or statistical rules that specify how external information data and candidate information data are to be included, excluded, or ordered for presentation to the user.

In one embodiment, a server, a terminal, and a communication network constitute a travel-support system that implements the claimed invention. The server includes at least one processor, a main memory, a non-volatile storage device, and a network interface. The processor executes a program stored in the storage device and loaded into the main memory. The terminal includes at least one processor, a display module, an input module such as a touchscreen, a microphone, and a communication module, and operates as a client device such as a smartphone or a tablet. The communication network includes at least one of a cellular network, a wireless local area network, and a wide area network.

The server executes server-side software implemented, for example, using an operating system such as a general-purpose server operating system, a web application framework such as a common HTTP application framework, and a database management system such as a relational database engine. The server communicates with external information providing apparatuses through application programming interfaces, which can include place-information APIs, weather-information APIs, and event-information APIs. The server also communicates with an external processing apparatus providing a natural language processing function and a generative AI model.

The server stores, in the storage device, modules including at least a user management module, a travel condition generation module, a dialogue management module, an external information acquisition module, an information selection module, a prompt management module, and a history management module. Each module is realized as executable instructions that the processor reads and executes.

The server uses a generative AI model implemented as a neural network, for example a transformer-based sequence-to-sequence model with multiple self-attention layers, feedforward layers, and layer normalization. The generative AI model is trained on large-scale text corpora using supervised learning and unsupervised language modeling. The server uses a natural language processing model that can be a separate model or a subset of the generative AI model, configured for tasks such as tokenization, part-of-speech tagging, named entity recognition, and intent classification.

The server represents travel condition data as a structured data object stored in a relational table or a key-value store. Fields of the travel condition data include at least a user identifier, a destination field, a start date field, an end date field, a list of preference categories, a list of prohibited items, a budget field, and a list of constraints such as mobility constraints or time-window constraints. The server maintains indexes on these fields in the database to allow efficient querying and updating of travel condition data.

The server constructs a prompt sentence for the generative AI model by concatenating template segments and inserting structured travel-related information into designated slots. The prompt management module manages prompt templates and fills them with context data. For example, the server generates a prompt sentence in the following form:

“User has booked a trip with the following information: destination=Paris; travel dates=May 1 to May 5; hotel area=near Eiffel Tower; user preferences=museums, landmarks, local events. Based on this information, generate structured travel condition data that includes destination, date range, main interests, and any inferred constraints such as time-of-day preferences and walking-distance limits. Output the conditions in a clear, machine-readable list.”

The server provides this prompt sentence as input to the generative AI model, which converts the prompt into a sequence of tokens and processes the tokens through the transformer layers. The model uses attention weights over the token sequence to infer dependencies between fields such as destination, dates, and preferences. The model generates an output sequence representing the travel condition data in a semi-structured textual form. The server parses the output by using deterministic parsing rules or regular expressions to extract fields and values and converts the output into the internal travel condition data structure.

The terminal acquires user identification information such as a login identifier and an authentication token through a user interface. The terminal transmits the user identification information and initial travel-related information to the server via a secure communication protocol. The user inputs travel-related information, for example by selecting a destination from a list, by entering dates, or by confirming reservation details. The terminal packages this information into a request and sends it to the server.

The server uses the travel condition generation module to merge the travel condition data generated by the generative AI model with existing data such as user profile data and past travel history stored in the database. The server computes feature values such as “frequency of museum visits,” “average daily walking distance,” and “preferred time slot for major attractions” by aggregating historical records. The server then updates the travel condition data fields by applying a condition update process that takes both generative AI output and historical statistics into account.

The server uses the dialogue management module to interpret user inquiries sent from the terminal. The user enters inquiry text such as “Please recommend places near my hotel that I can visit tomorrow afternoon” using a text input interface or a voice input interface of the terminal. The terminal transmits the inquiry text to the server. The server passes the inquiry text and the travel condition data to the natural language processing function.

The server causes the natural language processing function to perform tokenization, part-of-speech tagging, and named entity recognition on the inquiry text. The natural language processing function identifies time expressions, location references, and category words. The server converts “tomorrow afternoon” into a concrete time range by computing the date relative to the travel dates in the travel condition data and mapping “afternoon” to a predefined time interval. The server converts “near my hotel” into a geographic radius around the hotel coordinates stored in the travel condition data. The server constructs search condition data specifying parameters such as latitude, longitude, radius, category filter, and time window.

The server uses the external information acquisition module to send queries to external information providing apparatuses. The server transmits search condition data to a place-information API and obtains facility information including facility names, categories, geographic coordinates, opening hours, ratings, and tags. The server transmits location and time parameters to a weather-information API and obtains weather information including forecasted temperature, precipitation probability, and weather conditions. The server may also query event-information APIs for events in the destination during the relevant time period.

The server stores external information data in an in-memory data structure, such as a list of dictionaries or structured records. Each record includes keys for facility identifier, distance from hotel, opening hours, rating, and weather suitability score. The server computes the distance from the hotel by performing geospatial calculations, and computes a weather suitability score by evaluating whether predicted weather conditions are compatible with outdoor or indoor activities.

The server applies the information selection module to filter and rank candidate information data. The server uses a scoring function that combines features such as rating, distance, match to user preferences, and weather suitability. For example, the server assigns a weighted score defined as:

$$score = w 1 \times rating + w 2 \times preference\_match + w 3 \times weather\_suitability - w 4 \times distance\_penalty$$

The server obtains weighting parameters w1, w2, w3, and w4 from the recommendation policy data, which can be updated over time based on history data. The server selects a top set of candidate facilities according to the computed scores.

The server constructs a prompt sentence that instructs the generative AI model to produce a natural language explanation using the selected candidate information data. For example, the server can generate the following prompt sentence:

“User question: ‘Please recommend places near my hotel that I can visit tomorrow afternoon.’

Trip conditions: destination=Paris; hotel area=near Eiffel Tower; travel dates=May 1 to May 5; user preferences=museums, landmarks, local events.

### Candidate Places

1. Place A: museum, 10 minutes on foot from hotel, open from 10:00 to 18:00, highly rated.
2. Place B: landmark, 15 minutes on foot from hotel, open from 09:00 to 23:00, medium rating.
3. Place C: gallery, 8 minutes on foot from hotel, open from 12:00 to 20:00, highly rated.

Weather forecast for tomorrow afternoon: cloudy, no rain, comfortable temperature.

Using this data, generate a concise, user-friendly set of recommendations (3 items) with brief explanations, suggested visit times, and notes about walking distance. Do not invent any places that are not listed above.”

The server uses the prompt management module to ensure that the prompt sentence explicitly lists all candidate items and sets constraints such as “Do not invent any places that are not listed above.” By encoding these constraints as part of the prompt, the server reduces hallucinated outputs and ensures that the generative AI model only uses authoritative candidate information.

The server submits the prompt sentence and structured candidate information data to the generative AI model. The model represents each candidate item as embedded tokens and uses attention mechanisms to relate user preferences and facility features. The model outputs response text data that describes each recommended facility and provides recommendation reason text.

The server parses the output and performs validation by checking whether all facility names in the output appear in the candidate information data. If inconsistent names are detected, the server can discard or modify the response. The server then returns the response text data and structured candidate information to the terminal.

The terminal receives the response text data and displays it on the screen, for example as a list of cards, each card showing facility name, distance, recommended time, and explanation text. The user can select a facility to see detailed information. When the user selects a facility, the terminal transmits a request with the facility identifier to the server. The server responds with detailed data from the external information data and history data, which the terminal displays as a detailed screen.

The server records, as history data, interactions including user selections, skipped recommendations, and follow-up inquiries. The server stores history data in the storage device using a schema that links each user identifier with travel condition data snapshots, lists of presented candidate items, user actions, and response text identifiers. The server periodically or on demand constructs a prompt sentence instructing the generative AI model to analyze the history data, for example:

“Analyze the following history of user interactions, including accepted and rejected recommendations, for user ID 123. Derive updated weighting parameters for the recommendation scoring function and updated preference categories that better match the user's behavior. Generate updated travel condition data fields and recommendation policy parameters.”

The server inputs this prompt sentence and representative history samples into the generative AI model. The model outputs updated weighting parameters and preference categories in textual form, which the server parses into numeric and symbolic values and updates in the recommendation policy data. By updating the weighting parameters in this way, the server automatically personalizes the scoring function for each user.

The described architecture improves computer technology in several ways. First, the use of structured prompt sentences as control instructions between modules enables the server to integrate generative AI outputs tightly with deterministic data-processing pipelines. The server does not treat the generative AI model as a black box generating arbitrary text; instead, the server constrains the model through carefully designed prompt sentences, structured candidate information lists, and post-processing validation. This reduces inconsistent outputs and improves response reliability.

Second, the server reduces communication and computation overhead by generating search condition data from travel condition data and inquiry intent information before querying external information sources. The server does not query all possible data every time; instead, the server limits queries to relevant time windows, categories, and geographic areas, thereby reducing network traffic and external API calls.

Third, the server improves data management and calculation efficiency by using structured travel condition data and history data. The server indexes these data structures, caches frequently used travel condition data, and performs incremental updates rather than recomputing from scratch. This reduces database load and improves response time.

Fourth, the server improves recommendation accuracy and robustness by combining generative AI-based condition generation and explanation with deterministic, rule-based filtering and ranking that use explicit weighting parameters. By separating selection logic from explanation logic, the server ensures that recommendation ranking is computable, auditable, and optimizable, while still providing natural language explanations through the generative AI model.

Fifth, the generative AI model uses a neural network architecture with attention mechanisms, optimized through gradient-based learning with a loss function such as cross-entropy over next-token prediction. The training process adjusts weight parameters across attention heads and feedforward layers so that the model learns to condition its outputs on both the prompt sentence and structured context tokens. The server exploits this learned behavior by designing prompt sentences that encode system-level control information, which a human operator cannot easily emulate manually in real time.

The server processes user inputs, external information, and history data according to non-conventional rules that go beyond simple business logic. For example, the server enforces consistency constraints through prompt design and validation, uses learned weighting parameters to adjust feature importance dynamically, and combines multiple AI calls in a pipeline, thereby implementing a non-standard, technical process for orchestrating heterogeneous AI components. This approach is not a mere automation of human decision-making but a specific computational improvement in how the system manages context, reduces hallucination, and optimizes data flows.

In alternative embodiments, the server can embed the generative AI model locally instead of using an external processing apparatus, or use different neural network architectures such as encoder-only models for understanding and decoder-only models for generation, connected via intermediate feature representations. The server can also adjust prompt templates based on resource constraints, for instance by generating shorter prompts under high load to reduce processing time, while maintaining required constraints. The server can change storage formats for travel condition data, for example by using a document-oriented database instead of a relational database, without departing from the scope of the embodiments.

In another embodiment, the terminal can perform pre-processing of user text or speech using on-device models to reduce latency and bandwidth consumption, and then send compressed or summarized inquiry text to the server. The server can adapt the prompt sentences accordingly by including device-level context such as approximate location or network condition. By coordinating processing between server and terminal, the system further optimizes overall performance and robustness.

Through these configurations, the server, the terminal, and the communication network cooperate to implement a concrete, technical solution that improves the functioning of the computer system itself, including faster response generation, higher accuracy in recommendations, reduced inconsistent outputs, improved resource utilization, and enhanced adaptability based on accumulated history data.

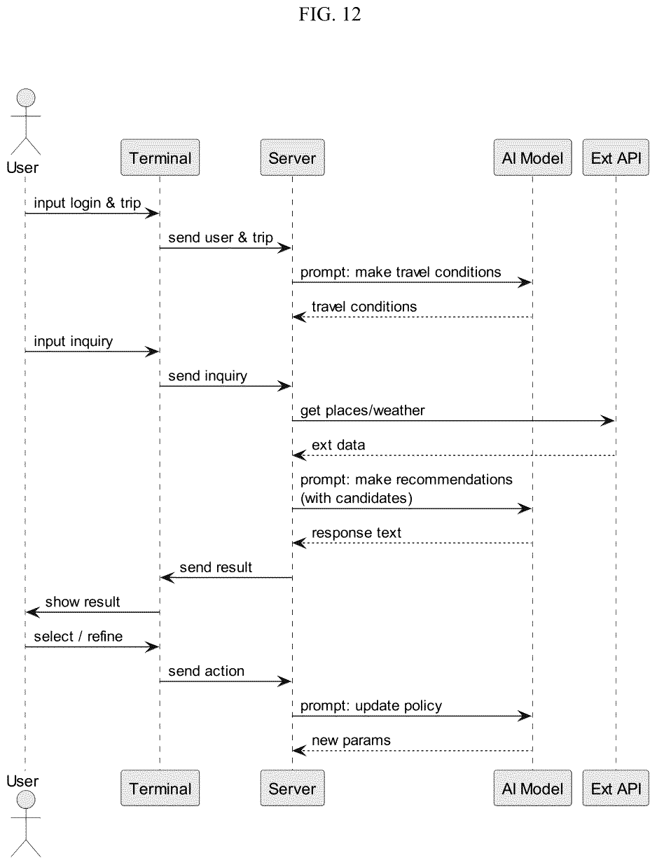

The following describes the processing flow using FIG. 12.

### Step 1

Server receives, from the terminal, user identification information and initial travel-related information.

Server takes as input a request payload including a user identifier, authentication token, destination text, planned travel dates, and optionally reservation data such as hotel name and address.

Server validates the authentication token, decodes the payload, and stores raw fields in temporary memory structures.

Server outputs a normalized data object in which text fields are cleaned (e.g., trimmed, lowercased where appropriate) and date strings are converted into internal date-time representations.

### Step 2

Server generates a first prompt sentence for travel condition generation and invokes the generative AI model.

Server takes as input the normalized data object from Step 1 and any existing user profile data loaded from a database, including past destinations and preference tags.

Server composes a prompt sentence by inserting these values into a predefined template, for example:

“User has booked a trip with the following information: destination=Paris; travel dates=May 1 to May 5; hotel area=near Eiffel Tower; user preferences=museums, landmarks, local events. Based on this information, generate structured travel condition data that includes destination, date range, main interests, and any inferred constraints such as time-of-day preferences and walking-distance limits. Output the conditions in a clear, machine-readable list.”

Server sends this prompt sentence as text input to the generative AI model and receives as output a generated text block describing inferred travel conditions.

Server parses the generated text using deterministic parsing rules to extract key-value pairs, and outputs a structured travel condition data object containing fields such as destination, date range, main interests, and constraints.

### Step 3

Server merges generative travel condition data with stored user profile and history data.

Server takes as input the travel condition data object from Step 2 and user-related records from a database, including past trip logs, accepted recommendations, and rejected categories.

Server performs data operations such as joining records by user identifier, computing aggregate statistics (e.g., count of museum visits, average daily movement distance), and deriving feature values.

Server updates or augments the travel condition data object by inserting derived attributes (e.g., “prefers morning visits,” “avoids long walks”), and outputs an enriched travel condition data object to be used as context in later steps.

### Step 4

Terminal initiates a dialog by sending an inquiry from the user to the server.

User enters natural language text, for example, “Please recommend places near my hotel that I can visit tomorrow afternoon,” using an input field or voice-to-text function on the terminal.

Terminal takes as input the user's text and the current session identifier, encapsulates them in a request payload, and transmits the payload to the server.

Terminal outputs a formatted network request containing the inquiry text, user identifier, and session context.

### Step 5

Server performs natural language understanding on the user inquiry and extracts intent and related items.

Server takes as input the inquiry text and the enriched travel condition data object from Step 3.

Server sends the inquiry text to a natural language processing function, which tokenizes the text, tags parts of speech, and identifies named entities such as time expressions (“tomorrow afternoon”) and relational phrases (“near my hotel”).

Server converts “tomorrow afternoon” into a concrete date and time range using the travel start date and an internal mapping of “afternoon” to hour intervals.

Server converts “near my hotel” into geographic constraints by retrieving hotel coordinates from the travel condition data and defining a search radius.

Server outputs an intent data object containing request type (e.g., “attraction recommendation”), time window, geographic area, and relevant categories.

### Step 6

Server generates search condition data for external information sources.

Server takes as input the intent data object from Step 5 and the enriched travel condition data object.

Server constructs search parameters such as latitude, longitude, search radius, category filters (e.g., museums, landmarks), and open-hours constraints aligned with the time window.

Server may also calculate budget constraints or maximum travel time based on travel condition data.

Server outputs a search condition data object formatted for use with external place-information, weather-information, and event-information APIs.

### Step 7

Server acquires external information data from external information providing apparatuses.

Server takes as input the search condition data object from Step 6.

Server sends an HTTP request with location and category parameters to a place-information API and receives as output a list of facility records containing coordinates, categories, opening hours, and ratings.

Server sends an HTTP request with destination and date-time parameters to a weather-information API and receives as output forecast records for the specified time window.

Server may also query event-information APIs using destination and date range constraints.

Server outputs combined external information data, stored in internal structures linking each facility or event with relevant weather and schedule information.

### Step 8

Server computes feature values and constructs candidate information data for ranking.

Server takes as input the combined external information data from Step 7 and the enriched travel condition data object.

Server calculates distances between the hotel location and each facility using geospatial distance formulas, and assigns a distance feature to each facility record.

Server computes a weather suitability feature per facility based on whether the activity is indoor or outdoor and the forecast conditions.

Server computes a preference-match feature by comparing facility categories and tags with user preferences stored in travel condition data.

Server aggregates these feature values and outputs a candidate information data list, where each item includes raw external information and computed features.

### Step 9

Server applies a scoring function to filter and rank candidate information data.

Server takes as input the candidate information data list from Step 8 and recommendation policy data, including weighting parameters for each feature.

Server calculates a score for each candidate by performing weighted summation: for example,

$$score = w 1 \times rating + w 2 \times preference\_match + w 3 \times weather\_suitability - w 4 \times distance\_penalty .$$

Server removes candidates that do not satisfy minimum constraints (e.g., closed during the time window, too far from hotel, below a rating threshold).

Server sorts the remaining candidates in descending order of score and selects a top subset (e.g., top 3 to 5 items).

Server outputs a ranked candidate information data subset to be used as the basis for natural language recommendations.

### Step 10

Server constructs a recommendation prompt sentence and invokes the generative AI model.

Server takes as input the user inquiry text, the enriched travel condition data object, and the ranked candidate information data subset from Step 9.

Server composes a detailed prompt sentence that embeds the user's question, a summary of trip conditions, a listing of each candidate with key attributes, and explicit constraints on the model's behavior, for example:

“User question: ‘Please recommend places near my hotel that I can visit tomorrow afternoon.’

Trip conditions: destination=Paris; hotel area=near Eiffel Tower; travel dates=May 1 to May 5; user preferences=museums, landmarks, local events.

### Candidate Places

1. Place A: museum, 10 minutes on foot from hotel, open from 10:00 to 18:00, highly rated.
2. Place B: landmark, 15 minutes on foot from hotel, open from 09:00 to 23:00, medium rating.
3. Place C: gallery, 8 minutes on foot from hotel, open from 12:00 to 20:00, highly rated.

Weather forecast for tomorrow afternoon: cloudy, no rain, comfortable temperature.

Using this data, generate a concise, user-friendly set of recommendations (3 items) with brief explanations, suggested visit times, and notes about walking distance. Do not invent any places that are not listed above.”

Server sends this prompt sentence to the generative AI model and receives as output response text data containing natural language descriptions and recommendation reasons aligned with the candidates.

Server outputs the validated response text data after performing checks to ensure that only listed candidates are referenced.

### Step 11

Server transmits the response text data and candidate details to the terminal for display.

Server takes as input the validated response text data from Step 10 and the ranked candidate information data subset.

Server formats a response message including text explanations, structured identifiers for each recommended facility, and metadata such as distance and recommended time ranges.

Server sends this message to the terminal over the communication network.

Terminal receives the message, parses the content, and renders a user interface in which recommended places are displayed as selectable items accompanied by the generated explanation text.

Terminal outputs a visual presentation that the user can read and interact with.

### Step 12

User interacts with the recommendations and optionally requests additional details or modifications.

User selects one of the recommended places on the terminal screen or submits a follow-up question such as “Can I visit Place A and Place B in the same afternoon?”

Terminal takes as input the user's selection or new inquiry text, attaches the relevant facility identifiers and session information, and sends a new request to the server.

Terminal outputs an updated interaction request that drives a new cycle of understanding, external data acquisition if needed, ranking, and generative response.

### Step 13

Server records interaction history and updates recommendation policy and travel conditions.

Server takes as input the user's actions from Step 12, including selections, rejections, and new queries, along with the underlying candidate information data and response text identifiers.

Server stores these items as history data in the database, linking them to the user identifier and the current trip context.

Server periodically constructs an update prompt sentence summarizing representative history for the user, for example:

“Analyze the following history of user interactions, including accepted and rejected recommendations, for this user. Derive updated weighting parameters for the recommendation scoring function and updated preference categories that better match the user's behavior. Generate updated travel condition data fields and recommendation policy parameters.”

Server sends this prompt sentence and selected history samples to the generative AI model and receives as output updated parameter values and preference descriptions.

Server parses the model output, updates internal weighting parameters and travel condition fields in the database, and outputs revised recommendation policy data and travel condition data that will be applied in subsequent recommendation cycles.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional travel support systems that rely on rule-based chatbots or static templates suffer from several technical limitations in how computing resources are used to generate personalized, context-aware responses. In many existing architectures, a server simply forwards user queries to a language model or a generic dialogue engine without maintaining a structured, machine-readable representation of the user's travel context, such as destination, schedule, accommodation area, and user preferences. As a result, each query is processed in isolation, causing redundant computation to infer the same context repeatedly, increasing network traffic and processing latency, and leading to inconsistent responses across multiple dialogue turns.

Furthermore, typical systems do not systematically construct prompt sentences for a generative AI model using a well-defined combination of (i) structured travel-related conditions maintained on the server, (ii) dialogue history shared with a dialogue processing apparatus, and (iii) external regional or cultural information obtained from external information sources. This absence of an integrated prompt-construction layer on the server side results in inefficient use of the generative AI model, because the model is not reliably provided with the minimal but sufficient set of context data needed to produce accurate and personalized responses. Consequently, the system may generate irrelevant or inconsistent answers, and may waste computational resources by processing overly long or poorly structured prompts.

Additionally, in many conventional implementations, the server does not extract user preferences or constraints across multiple interactions and does not reuse such extracted data to optimize subsequent prompt sentences. Without such cross-session preference extraction and reuse, the computing system cannot effectively exploit previously computed information, leading to repeated inference of identical or similar user attributes, increased load on storage and processing components, and degraded responsiveness. This also makes it difficult for the system to maintain a stable user model that can guide the generative AI model toward consistent, user-tailored behavior over time.

Moreover, existing systems often treat external business information or sightseeing information for a target region as ad hoc, unstructured text appended to a query. Such approaches do not couple the external information with the structured movement-related conditions managed by the server, and do not use a controlled selection process prior to constructing prompt sentences. This can cause unnecessary data transfer to the generative AI model, increased token usage, longer processing times, and responses that are not optimally aligned with the user's actual movement conditions.

Accordingly, there is a need for an improved computer-implemented system and server-side processing method that (i) acquires and maintains structured information representing conditions related to user movement, (ii) programmatically constructs optimized prompt sentences for a generative AI model based on this structured information, dialogue history, and selected external information, and (iii) uses these prompt sentences to control the generative AI model so as to generate context-aware, personalized responses with reduced redundancy and improved computational efficiency. There is also a need to technically improve the way the server coordinates between a dialogue processing apparatus and a generative AI model, such that dialogue sessions are initiated and maintained using shared structured context, leading to more stable and efficient natural language interaction from the perspective of computer system design and operation.

The specific processing by the specific processing unit 290 of the data processing device 12 in Example 2 is realized by the following means.

The present invention provides a server comprising a processor and a storage, the processor being configured to acquire user identification information and movement information from a user terminal, generate structured information including conditions related to movement for each user, and store the structured information in the storage; to construct, based on the structured information and input information from the user, a prompt sentence including instruction content for automatically generating or updating the conditions related to movement, and to input the prompt sentence to a generative AI model so that the generative AI model updates the conditions related to movement; to attach the updated conditions related to movement as context information to a dialogue processing apparatus having a natural language processing function, to transmit the context information to the dialogue processing apparatus, and to cause the dialogue processing apparatus to start and maintain a dialogue session with the user based on the conditions related to movement; to construct a prompt sentence for instructing generation of response content to the user by including a dialogue text transmitted from the user terminal, the conditions related to movement, and regional information or cultural information acquired from an external information source, and to input the prompt sentence to the generative AI model so that the generative AI model generates a response text in natural language; and to transmit the generated response text to the user terminal in association with a dialogue history and the conditions related to movement. This enables the computing system to efficiently manage and reuse structured movement-related context, dynamically construct optimized prompt sentences for the generative AI model, reduce redundant computation across dialogue turns, and generate consistent, personalized responses that reflect both the user's travel conditions and selected regional or cultural information, thereby improving the technical performance of the server-centric dialogue processing architecture.

The term “processor” refers to a hardware computing element or a combination of hardware and firmware that executes instructions, performs arithmetic and logical operations, and controls data flow within the system, including a central processing unit, a microcontroller, or a processing core in an integrated circuit.

The term “storage” refers to a hardware memory resource configured to store data and program instructions, including volatile memory, non-volatile memory, or a combination thereof, such as semiconductor memory, magnetic storage, or optical storage.

The term “user identification information” refers to data used to uniquely or pseudo-uniquely distinguish one user from another, including identifiers such as user IDs, account IDs, device IDs, or authentication tokens.

The term “movement information” refers to information relating to a user's travel or physical relocation, including at least one of destination, departure location, schedule, accommodation location, planned route, or mode of transportation.

The term “conditions related to movement” refers to structured parameters derived from movement information that represent constraints, attributes, or context of a user's travel, including at least one of destination area, date range, number of nights, budget level, accommodation area, transportation constraints, or category of activities.

The term “structured information” refers to data organized in a machine-readable format with explicitly defined fields or attributes, such as records, objects, or key-value pairs, that represent the conditions related to movement in a consistent schema.

The term “user terminal” refers to an information processing apparatus operated by a user for communication with the server, including at least one of a smartphone, a tablet computer, a desktop computer, a notebook computer, or an embedded communication device.

The term “prompt sentence” refers to a machine-generated or programmatically constructed text sequence provided as input to a generative AI model, the text sequence including instructions, context, or constraints that guide the generative AI model in generating an output.

The term “generative AI model” refers to a machine learning model configured to generate output content, such as natural language text, in response to input data including a prompt sentence, the model being implemented, for example, as a neural network or a large language model.

The term “dialogue processing apparatus” refers to a computing component or service that performs natural language understanding, dialogue state management, and message routing for interactions with a user, including at least one of a chatbot engine, a dialogue manager, or a conversational middleware.

The term “natural language processing function” refers to a capability of a computing component to analyze, interpret, or generate human language, including at least one of tokenization, syntactic analysis, semantic analysis, intent recognition, or response generation.

The term “context information” refers to information supplied to the dialogue processing apparatus or the generative AI model that characterizes the state of the interaction or the user's situation, including at least the conditions related to movement and optionally user preferences or constraints.

The term “dialogue session” refers to a series of related exchanges between a user and the system, maintained over time by associating multiple user inputs and system outputs with a common session identifier and shared context information.

The term “dialogue text” refers to natural language content transmitted as part of a dialogue session, including user utterances, questions, responses, or statements expressed in textual form.

The term “dialogue history” refers to stored data representing past dialogue texts exchanged in one or more dialogue sessions, including at least prior user inputs and system responses, used to maintain continuity and context.

The term “external information source” refers to a computing resource or service external to the server that supplies additional data, including at least one of a remote database, a web service, an information provider server, or a content delivery system.

The term “regional information” refers to information about a geographic area relevant to a user's movement, including at least one of facility information, business information, sightseeing information, public transportation information, or safety information.

The term “cultural information” refers to information about social norms, customs, practices, etiquette, or events associated with a particular region or community.

The term “business information” refers to data describing commercial entities or service providers, including at least one of names, locations, categories, operating hours, or user ratings.

The term “sightseeing information” refers to data describing points of interest or activities for visitors, including at least one of tourist attractions, landmarks, events, tours, or recommended routes.

The term “target region” refers to a geographical scope associated with a user's movement, including at least one of a country, a region, a metropolitan area, or a locality specified or inferred from movement information.

The term “external information providing apparatus” refers to a computing system or service configured to provide regional information, cultural information, business information, or sightseeing information upon request from the server.

The term “prior knowledge” refers to information included in a prompt sentence as background facts or constraints for the generative AI model, the information being selected in advance by the server from stored data or external information sources.

The term “response text” refers to natural language content output by the generative AI model in response to a prompt sentence, formatted as text for presentation to the user.

The term “preferences” refers to characteristics inferred or specified for a user that indicate favored options or tendencies, including at least one of preferred price range, preferred categories of activities, dietary requirements, or communication style.

The term “constraints” refers to limiting conditions applicable to a user's movement or interaction, including at least one of budget limits, time windows, mobility restrictions, or language limitations.

Various embodiments of the invention will now be described as examples of modes for carrying out the invention. In the following description, a “server” denotes a data processing apparatus including at least one processor and at least one storage device, a “terminal” denotes a user-operated information processing device such as a smartphone or a personal computer, and a “user” denotes a person operating the terminal.

In a representative embodiment, the server is implemented as a computing system including a multicore central processing unit, a main memory, a non-volatile storage device such as a solid-state drive, and a network interface. The server executes an operating system such as a general-purpose server operating system and runs application programs implemented, for example, using a programming language such as Python, Java, or JavaScript. The server uses a relational database management system such as a general-purpose SQL database (for example, a system of the MySQL type or PostgreSQL type) as storage for persistent data, and may further use an in-memory key-value store such as a cache server (for example, a system of the Redis type) as a fast-access context store.

The terminal is implemented as a mobile communication device or a general-purpose computer comprising a processor, a memory, a display unit, an input unit such as a touch panel or keyboard, and a wireless or wired communication module. The terminal executes an operating system such as a mobile operating system or a desktop operating system, and runs a web browser or a native application providing a chat user interface. The user views text and other information on the display unit and inputs natural-language messages through the input unit.

The server executes a program that acquires user identification information and movement information from the terminal and transforms these data into structured information representing conditions related to movement. For example, the server receives, via a secure communication protocol such as HTTPS, data indicating a destination city, a country, an arrival date, a departure date, an accommodation address, and a travel budget, together with a user identifier. The server uses a database management system such as the above-mentioned SQL database to store the raw reservation record in a normalized schema consisting of tables for users, trips, and accommodations.

The server executes a data processing module implemented as a program in a language such as Python. This module reads the raw reservation record from the database by issuing SQL queries and creates a structured data object, such as an internal record or key-value mapping, in which the server computes derived attributes. For example, the server calculates the number of nights as the difference between the departure date and the arrival date, classifies the destination city into a region code, converts the accommodation address into a standardized area descriptor, and maps budget values into discrete levels such as “low”, “mid-range”, or “high”. The server thereby constructs movement-related conditions as a fixed-schema data structure, for example including fields such as user_id, trip_id, destination_region, date_range, number_of_nights, accommodation_area, budget_level, and inferred interests.

The server stores the movement-related conditions as structured information in the storage, separate from the raw reservation data. For instance, the server maintains a context table or a key-value store where each record is indexed by a composite key including a user identifier and a trip identifier. Because the server maintains this structured context, the server is not required to repeatedly parse free-form reservation data for each user query, which improves processing speed and reduces redundant database access.

The server further executes a dialogue integration module that cooperates with a dialogue processing apparatus. The dialogue processing apparatus is realized, for example, as a separate software component or service that implements natural language understanding and dialogue management using natural language processing libraries such as those of the NLTK type or spaCy type, or equivalent frameworks. The dialogue processing apparatus performs tokenization, part-of-speech tagging, named-entity recognition, and intent classification for each user utterance. The server transmits the movement-related conditions to the dialogue processing apparatus as context information associated with a dialogue session identifier so that the dialogue processing apparatus can access this context when translating natural-language user inputs into structured intents.

The server constructs prompt sentences for a generative AI model by programmatically assembling text from multiple data sources. The generative AI model is implemented as a neural network of the transformer architecture, including an input embedding layer, a plurality of self-attention layers, feed-forward sublayers, and an output projection layer. The generative AI model has been trained, for example, using an unsupervised or self-supervised learning procedure on a large corpus of natural-language documents and then optionally fine-tuned using instruction-response pairs. During training, the model minimizes a loss function such as cross-entropy between predicted token distributions and actual next tokens, and performs weight updates using an optimization algorithm such as stochastic gradient descent with adaptive moments. The model runs on specialized accelerator hardware such as graphics processing units, tensor processing units, or equivalent vector computation devices.

The server configures the generative AI model as a remote service accessed through an application programming interface. Internally, the model receives a tokenized representation of the prompt sentence, applies a sequence of linear transformations and non-linear activation functions, and outputs a sequence of tokens representing the response text. Because the server designs the prompt sentence to contain explicit structured context and selected external information, the generative AI model can converge to appropriate responses with fewer tokens and reduced computational overhead compared to naive prompts that repeat all context at each call.

The server uses the movement-related conditions as primary features when constructing a prompt sentence. Additionally, the server retrieves a dialogue history from storage or from the dialogue processing apparatus and incorporates the essential parts of the history into the prompt sentence in a condensed form, for example by including only the last several user-system exchanges or by summarizing older parts of the conversation using a separate summarization model or rule-based compression. The server may further call an external information providing apparatus, such as a web service offering regional business information or sightseeing information, and select a small subset of candidate entities that satisfy constraints determined from the movement-related conditions. For example, if the conditions indicate that the accommodation area is a specific district and the budget level is “mid-range”, the server filters external data to retain only relevant business entries.

The server then concatenates these elements into a prompt sentence that guides the generative AI model to generate a response. Examples of prompt sentences include:

“You are a travel assistant. The user has booked a trip to New York City from March 10 to March 15 and is staying near Times Square. The user asked: ‘Please recommend restaurants I should visit during my New York trip.’ The user prefers mid-range prices and enjoys Italian and Japanese food. Based on this context, suggest 5 specific restaurants in Manhattan, with a one-sentence explanation for each recommendation. Consider walking distance from Times Square when possible.”

“You are a travel assistant. The user will visit Tokyo and Kyoto in Japan next month. The user asked: ‘What cultural customs should I know when visiting shrines in Japan?’ Explain the main customs and etiquette at Shinto shrines, including how to approach the entrance, how to cleanse at the purification fountain, how to pray, and what behaviors should be avoided. Provide step-by-step, practical guidance for a first-time foreign visitor.”

“You are a travel assistant. The user is currently traveling in Paris, France and has lost their passport. Provide clear, step-by-step instructions on what the user should do next, including contacting local police, contacting their country's embassy or consulate, and how to manage hotel check-in or transport changes while waiting for a new passport.”

The server generates such prompt sentences algorithmically, using template-based concatenation combined with conditional insertion rules. For example, the server includes budget constraints only when the budget level is present in the movement-related conditions, and includes external business information only when the filtered set of candidate entities is non-empty. This non-conventional, rule-based prompt construction ensures that the prompt sentence is neither excessively long nor incomplete, thereby improving the technical performance of the generative AI model by reducing token count and improving context focus.

The server also performs preference extraction over multiple dialogue sessions. The server periodically analyzes the dialogue history stored in the storage using pattern-matching rules and machine learning models, such as a classifier or embedding-based clustering algorithm, to identify recurrent preferences or constraints, for instance, repeated requests for vegetarian restaurants, avoidance of late-night activities, or preference for public transportation. The server then updates the stored movement-related conditions or an associated user profile with these derived attributes. When a new prompt sentence is constructed, the server inserts descriptions of such preferences into the prompt sentence, enabling the generative AI model to generate responses that remain consistent with the user's historical behavior without requiring the user to restate these preferences in each session.

The terminal provides user interaction and renders the outputs of the system. The terminal presents a chat interface implemented, for example, using a web framework such as React.js or a mobile framework. The terminal displays prompts from the server and accepts natural-language text from the user. The terminal sends the user's text, together with a session identifier, to the server over a network connection. The terminal receives response texts generated by the generative AI model and post-processed by the server, and displays them as chat bubbles, lists, or structured cards. In some embodiments, the terminal enables the user to tap on a recommended business entry to invoke a map application, thereby triggering location-based services and demonstrating that the invention is tied to physical-world navigation and device control.

The described architecture yields technical effects that go beyond mere automation of human mental steps. Because the server maintains movement-related conditions as structured information and uses them systematically in prompt construction, the server can reuse previously computed context across multiple dialogue turns and across sessions. This reduces the number of database read operations, minimizes repeated extraction of identical information from unstructured text, and shortens prompt sentences by omitting redundant details. As a result, the server reduces network traffic to the generative AI model service, decreases the number of tokens processed per request, and thereby lowers processing latency and improves throughput. These improvements constitute enhancements to the functioning of the computer system itself.

Moreover, the server's algorithm for selecting external regional and cultural information prior to prompt construction optimizes data flow between the server and the generative AI model. Instead of sending large volumes of unfiltered external information, the server performs selection and compression at the server side, for example by applying search queries to an index such as an Elasticsearch-type engine and by limiting the number of selected entities according to a specified maximum. This controlled data selection leads to more efficient use of memory and computation within the generative AI model and reduces the risk of timeouts or failures due to excessively long inputs.

The generative AI model itself is used in a technically constrained and concrete manner. The server configures model parameters such as maximum sequence length, temperature, and top-k or nucleus sampling thresholds to obtain deterministic or semi-deterministic behavior suitable for travel assistance. The server monitors response length and enforces truncation or regeneration when the response does not satisfy structural requirements encoded in the prompt sentence. By coupling prompt construction with model parameter control, the server achieves a non-trivial synergy that improves stability and reliability of the model's outputs, which is a technical improvement over naive, uncontrolled use of large language models.

In another embodiment, the server uses a local inference engine for the generative AI model, for example a reduced-size transformer network running on a graphics processing unit installed in the server. The server loads quantized model weights into GPU memory and processes token batches using parallel matrix multiplications. Because the server maintains movement-related conditions and external information in structured form, the server can limit input size for the local model and thereby allow real-time inference suitable for deployment in network-limited environments. This embodiment demonstrates that the invention improves the technical efficiency of on-premises AI inference systems.

In a further embodiment, the server implements a modular architecture including separate components for context management, prompt construction, external data retrieval, and generative model interfacing. Each component communicates via well-defined interfaces, for example by exchanging structured messages over an internal message bus. This modularization enables independent scaling of the generative AI model interface component and the context management component, thereby improving resource utilization and fault tolerance of the overall system. The separation also facilitates deployment across multiple physical machines, such that one machine operates as a database and context server, while another machine operates as an AI inference server equipped with specialized accelerators.

The system's manner of combining rule-based prompt construction with learned generative capabilities differs from conventional purely rule-based systems and from naive end-to-end generative systems. The server applies explicit rules and algorithms to determine which context fields, which segments of dialogue history, and which external information items should be included in a prompt sentence. This hybrid approach allows the system to enforce domain-specific constraints and to maintain stable, reproducible behavior while still leveraging the flexible generation capabilities of the generative AI model. Consequently, the system reduces errors such as irrelevant recommendations and inconsistent references to user conditions.

Alternative embodiments can vary specific hardware and software implementations while preserving the core technical concept. For example, the server may use a non-relational database such as a document store to store movement-related conditions instead of a relational database. The dialogue processing apparatus may be integrated into the same physical server as the generative AI model interface, or may be hosted by a separate service. The generative AI model may be a multilingual model trained to handle multiple languages, in which case the server includes language codes in the movement-related conditions and instructs the model via the prompt sentence to answer in the user's preferred language. The external information providing apparatus may be an internal knowledge base stored in a local index, or a remote service accessible via a network.

In all of these embodiments, the server, the terminal, and the user cooperate so that the system acquires movement-related conditions, maintains them in structured form, generates optimized prompt sentences for a generative AI model, and produces context-aware, personalized responses. The described data structures, processing algorithms, and modular architecture provide technical improvements in computation efficiency, accuracy, and system-level behavior, and thereby constitute concrete modes for carrying out the claimed invention.

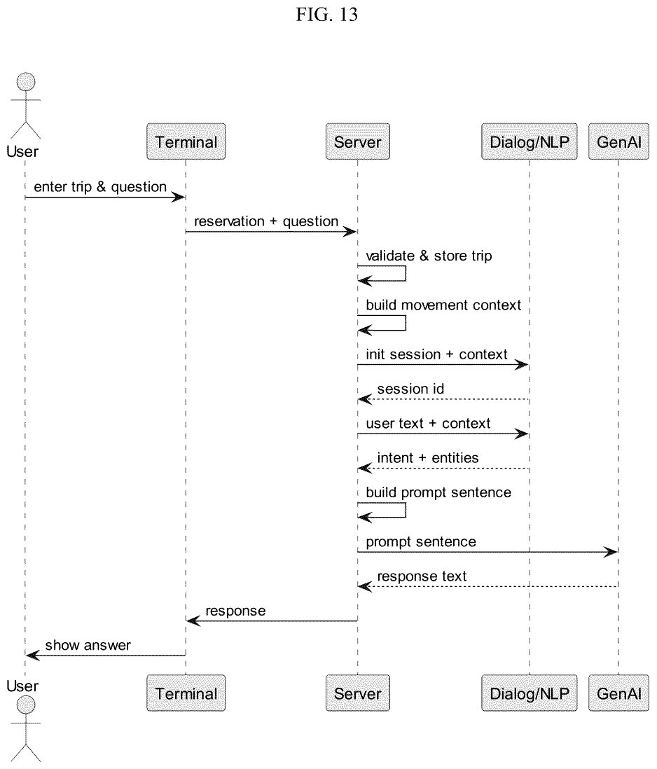

The following describes the processing flow using FIG. 13.

### Step 1

The user operates the terminal to access a travel reservation interface and inputs movement information including at least a destination, travel dates, and accommodation information. The terminal collects this input as structured data fields (for example, text strings for locations and dates) and sends them together with user identification information to the server via a network request. The input of this step is user-provided reservation data and a user identifier, and the output of this step is a formatted request message transmitted from the terminal to the server.

### Step 2

The server receives the reservation request from the terminal and validates the data. The server checks that required fields are present, parses date strings into internal date objects, and verifies that the arrival date precedes the departure date. The input of this step is the request message containing raw reservation fields, and the output is a validated and normalized reservation record stored in a temporary data structure in server memory.

### Step 3

The server stores the validated reservation record in a database system. The server uses a database management system such as a general-purpose SQL database (for example, of the MySQL or PostgreSQL type) to insert user identifiers, trip identifiers, destinations, date ranges, and accommodation data into relational tables. The input of this step is the normalized reservation record in memory, and the output is one or more persistent database records accessible via query operations.

### Step 4

The server generates structured movement-related conditions from the stored reservation record. The server reads the record from the database using a query, computes derived values such as number of nights from the stored dates, categorizes the destination into a region code, and maps numeric budget values into discrete budget levels. The server then assembles these fields into a structured data object representing conditions related to movement. The input of this step is the database record of the reservation, and the output is a movement-condition object stored in server memory.

### Step 5

The server stores the movement-condition object in a dedicated context storage area. The server either inserts a record into a context table in the database or writes a key-value pair into a fast-access store such as an in-memory cache. The key is constructed from the user identifier and trip identifier, and the value is the movement-condition object. The input of this step is the movement-condition object, and the output is a persistently or semi-persistently stored context entry that can be retrieved by future server operations.

### Step 6

The terminal initiates a dialogue session by requesting a travel assistant chat interface from the server. The terminal sends a session-start request containing the user identifier and optionally the selected trip identifier. The server receives this request and uses it to locate the corresponding movement-condition object in the context storage. The input of this step is the session-start request from the terminal, and the output is a retrieved movement-condition object and a newly created dialogue session identifier generated by the server.

### Step 7

The server transmits the movement-related conditions to a dialogue processing apparatus and initializes dialogue state. The server sends a message containing the dialogue session identifier and the movement-condition object to the dialogue processing apparatus, which maintains dialogue state and performs natural language understanding. The input of this step is the retrieved movement-condition object and the dialogue session identifier, and the output is an initialized dialogue session within the dialogue processing apparatus that is bound to the user's movement context.

### Step 8

The terminal renders a chat interface and displays a context-aware greeting. Using the dialogue session identifier or a token received from the server, the terminal opens a conversation screen indicating the destination or other conditions (for example, “You are planning a trip to New York”). The input of this step is the session identifier and optional greeting message from the server, and the output is a graphical user interface on the terminal that accepts user text input.

### Step 9

The user enters a natural-language query into the chat interface. For example, the user may type “Please recommend restaurants I should visit during my New York trip.” The terminal captures the input as a text string and sends it, together with the dialogue session identifier and the user identifier, to the server. The input of this step is the user's free-text message, and the output is a message packet containing the text and identifiers transmitted to the server.

### Step 10

The server receives the user message and forwards it, along with the associated movement-related conditions, to the dialogue processing apparatus. The server retrieves the movement-condition object from context storage using the user identifier and session identifier and sends both the user text and the conditions to the dialogue processing apparatus. The input of this step is the message packet from the terminal, and the output is a combined payload of user text and structured conditions delivered to the dialogue processing apparatus.

### Step 11

The dialogue processing apparatus analyzes the user's text to determine intent and extract entities. The dialogue processing apparatus applies natural language processing operations such as tokenization, part-of-speech tagging, and named-entity recognition using libraries of the NLTK or spaCy type. It identifies an intent category (for example, restaurant recommendation) and entities such as cuisine type, price sensitivity, or location references. The input of this step is the raw user text and the movement-condition object, and the output is an interpreted intent structure that describes the user's goal and extracted parameters.

### Step 12

The server or the dialogue processing apparatus merges the intent structure with the movement-related conditions to create a response context. For instance, the system combines the destination city and accommodation area from the conditions with specific cuisine preferences from the user's current message. The input of this step is the intent structure and the movement-condition object, and the output is a combined context data structure that specifies what response should address and under which movement-related constraints.

### Step 13

The server optionally queries an external information providing apparatus for regional business or sightseeing information. Based on the combined context, the server constructs a search query specifying criteria such as location proximity to the accommodation area and budget level. The server sends this query to an external data source and receives a list of candidate entities such as restaurants or attractions. The input of this step is the combined context structure, and the output is a filtered list of external entities relevant to the movement conditions.

### Step 14

The server selects and reduces external information to limit input length and relevance. The server sorts candidate entities by criteria such as rating or distance and selects a top subset, for example up to a predetermined maximum count. The server extracts only necessary attributes such as names, approximate locations, and brief descriptions. The input of this step is the full list of candidate entities, and the output is a reduced and structured list that can be embedded into a prompt sentence without excessive length.

### Step 15

The server constructs a prompt sentence for a generative AI model using the combined context and selected external information. The server uses rule-based templates to assemble a natural-language instruction that includes the user's movement-related conditions, current question, and any chosen external entities. For example, the server may construct the following prompt sentence:

“You are a travel assistant. The user has booked a trip to New York City from March 10 to March 15 and is staying near Times Square. The user asked: ‘Please recommend restaurants I should visit during my New York trip.’ The user prefers mid-range prices and enjoys Italian and Japanese food. Based on this context, suggest 5 specific restaurants in Manhattan, with a one-sentence explanation for each recommendation. Consider walking distance from Times Square when possible.”

The input of this step is the combined context structure, the reduced external entity list, and the user's latest query, and the output is a single prompt sentence string ready for input to the generative AI model.

### Step 16

The server sends the prompt sentence to a generative AI model and requests a response. The server connects to a generative AI service implemented as a transformer-based neural network and transmits the prompt sentence as tokenized input, together with control parameters such as maximum length and temperature. The input of this step is the prompt sentence and model parameters, and the output is a token sequence representing a natural-language response generated by the generative AI model.

### Step 17

The server receives the response tokens from the generative AI model and reconstructs a response text. The server converts the tokens into a character string, checks for protocol-level errors, and performs basic formatting, such as trimming leading or trailing whitespace. The input of this step is the token sequence from the generative AI model, and the output is a plain-text response suitable for further processing.

### Step 18

The server optionally post-processes the response text for structure and compliance with constraints. The server may parse the response to detect item boundaries, check whether the number of recommendations matches the number requested in the prompt sentence, and apply content filters. If necessary, the server may modify minor formatting issues or regenerate the response with adjusted parameters. The input of this step is the raw response text from the generative AI model, and the output is a structured response object containing the final response text and possibly a list of extracted items.

### Step 19

The server associates the response with the dialogue history and movement-related conditions. The server writes the user's query and the generated response into a dialogue history store, indexing them by the dialogue session identifier and linking them with the movement-condition object. The input of this step is the structured response object and the session metadata, and the output is an updated dialogue history record that reflects the new exchange.

### Step 20

The server sends the finalized response to the terminal. The server creates a response message containing the response text and any structured recommendation data such as restaurant names and locations, and transmits this message via the network to the terminal. The input of this step is the structured response object, and the output is a network message delivered to the terminal.

### Step 21

The terminal receives the response message and updates the user interface. The terminal parses the response message, displays the response text as a chat bubble, and may render recommended items in a list with selectable entries. The input of this step is the response message from the server, and the output is a visual representation of the system's answer on the terminal's display.

### Step 22

The user reviews the response on the terminal and may perform additional actions based on the provided information. The user can, for example, tap on a recommended restaurant to open a map application or type a follow-up question such as “Please suggest vegetarian options near my hotel.” The input of this step is the displayed response and interactive elements, and the output is either a physical action of the user in the real world (such as navigating to a destination) or a new textual query that will be captured by the terminal and sent back to the server.

### Step 23

The server, upon receiving a follow-up query, reuses the stored movement-related conditions and dialogue history to construct an updated prompt sentence. The server retrieves the context and history, extracts any additional preferences inferred from previous exchanges, and repeats the process of external data retrieval and prompt generation. The input of this step is the new user message and stored context, and the output is a new prompt sentence that reflects the cumulative dialogue and movement-related conditions, which is again submitted to the generative AI model for response generation.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialog systems that employ machine learning models to answer user inquiries typically rely on fixed application logic and static dialog flows. Such systems treat a large-scale language model merely as a black-box answer generator and do not explicitly manage how prompt sentences are constructed, updated, and reused in association with rich, context-specific condition information. As a result, these systems exhibit several technical problems from a computer technology standpoint.

First, conventional systems generally fail to maintain a coherent and efficiently reusable context across multiple interactions. Condition information such as user identification information, order information, travel information, and behavior history is often stored in an ad hoc manner without a structured linkage to the prompt sentences provided to a generative AI model. This leads to redundant data retrieval and repeated reconstruction of similar context for each query, increasing processing load on the server and latency for the user terminal.

Second, conventional systems do not systematically integrate emotion analysis into the control path of answer generation at the prompt level. Emotion analysis, when present, is often used only to select from pre-authored templates or to adjust superficial wording at the user interface layer. The generative AI model is not guided by prompt sentences that explicitly encode emotion-dependent instructions. As a consequence, the model is underutilized, and the system cannot reliably generate responses whose content and structure are dynamically adapted to the detected emotional state, resulting in suboptimal dialog quality and inefficient use of computational resources.

Third, conventional systems lack a generalized mechanism for using a generative AI model to generate and update condition information itself, including travel conditions, nutrition-related conditions, and recommendation conditions. Instead, condition generation is typically implemented as static application logic or rule-based algorithms executed on the server. This rigid architecture makes it difficult to incorporate complex contextual reasoning into condition generation and update, and forces the server to perform separate algorithmic processing in addition to model inference, leading to increased complexity and resource consumption.

Fourth, conventional systems often handle information recommendation and multi-domain condition handling (for example, food, travel, and general content recommendations) through separate pipelines. There is no unified treatment of these tasks as prompt-driven transformations over structured condition information and user queries. This fragmentation complicates state management, increases the number of service components, and reduces scalability and maintainability at the system level.

Accordingly, there is a need for an improved computer-implemented dialog system that (i) centrally manages user-related condition information as context information, (ii) systematically generates, updates, and applies prompt sentences to a generative AI model based on such context information and detected emotion states, and (iii) unifies answer generation and information recommendation in a single, prompt-driven architecture. Such a system should reduce redundant computation, improve the coherence and relevance of responses across multiple turns, and enhance the adaptability of the dialog to user emotion, thereby improving the overall operation of the server and dialog processing program as computer technology.

The specific processing by the specific processing unit 290 of the data processing device 12 in Application Example 2 is realized by the following means.

The present invention provides a server comprising a processor configured to acquire user identification information and user situation information from input information received from a user terminal, to generate condition information corresponding to the user situation information based on a first prompt sentence supplied to a generative AI model, to register the condition information as context information for a dialog processing program, to generate response information by supplying a second prompt sentence to the generative AI model, the second prompt sentence being constructed using the context information and a natural language inquiry sentence acquired from the user terminal, to identify an emotional state of a user by supplying the natural language inquiry sentence to an emotion analysis program, to generate adjusted response information by supplying a third prompt sentence to the generative AI model, the third prompt sentence including an instruction to adjust content or expression style of the response information according to the emotional state, and to update the context information by generating updated condition information based on user behavior history information and dialog history information using a fourth prompt sentence supplied to the generative AI model. This enables the server to control the generative AI model through explicitly managed prompt sentences that are dynamically constructed from structured context information and emotion analysis results, thereby improving coherence and efficiency of dialog processing, reducing redundant context reconstruction, unifying answer generation and recommendation processing across different service domains, and enhancing the technical performance of the computer-implemented dialog system.

The term “processor” refers to a hardware or virtual computation unit, such as a central processing unit or an execution core in a server or computing device, that executes program instructions to perform information processing operations described in the present specification.

The term “user identification information” refers to information that uniquely or quasi-uniquely associates an interaction with a particular user, such as a user identifier, login identifier, authentication token, or other identifier stored in a data structure.

The term “user situation information” refers to information indicating a current or recent state related to a user, including but not limited to order information, travel information, location information, terminal type, time information, or other contextual parameters acquired from input information.

The term “condition information” refers to structured information generated or updated based on user identification information, user situation information, behavior history information, dialog history information, or analysis results, and used as context for dialog processing, answer generation, or recommendation processing.

The term “prompt sentence” refers to a text sequence or other symbol sequence supplied as input to a generative AI model, the text sequence explicitly describing an instruction, condition, or constraint that guides output generation by the generative AI model.

The term “generative AI model” refers to a machine-learned information processing model that receives a prompt sentence or other input data and generates output data such as natural language text, structured text, or other information, based on statistical patterns learned from training data.

The term “dialog processing program” refers to a software component or software service that manages dialog state, intent handling, and interaction flow between a user and a system, using context information and generated responses to conduct multi-turn dialog.

The term “context information” refers to information maintained across one or more dialog turns, including condition information, user identification information, user situation information, emotion information, and other parameters, and used to interpret subsequent user inputs and to generate responses.

The term “user terminal” refers to an information processing device operated by a user, such as a mobile terminal, a portable information terminal, a personal computer, or another client device capable of transmitting input information and displaying response information.

The term “natural language inquiry sentence” refers to a sequence of characters, words, or utterances that express a user's question, request, or statement in a human language, which is transmitted from a user terminal to the server for analysis and response generation.

The term “response information” refers to information that is generated by the generative AI model based on a prompt sentence and is intended to be provided to a user as a reply to a natural language inquiry sentence.

The term “adjusted response information” refers to response information that has been generated or modified according to an instruction contained in a prompt sentence, such instruction specifying an adjustment to content, structure, or expression style of the response information in view of an emotional state or other context.

The term “emotion analysis program” refers to a software component or software service that receives input such as a natural language inquiry sentence or dialog history, and outputs an estimated emotional state or emotion label associated with a user.

The term “emotional state” refers to an estimated affective condition of a user, such as happiness, sadness, anger, confusion, excitement, or anxiety, derived from processing by the emotion analysis program based on user input or behavior.

The term “storage device” refers to a physical or logical data storage apparatus, such as a memory device, a disk device, or a storage subsystem, used to store behavior history information, dialog history information, condition information, and other data.

The term “user behavior history information” refers to information indicating past operations or actions performed by a user with respect to a system, including but not limited to past queries, clicks, selections, orders, travel bookings, or content consumption records.

The term “dialog history information” refers to information indicating content and sequence of past dialog turns between a user and the system, including natural language inquiry sentences, response information, timestamps, and associated context.

The term “nutrition information” refers to information related to nutritional elements associated with a consumable item, such as energy value, macro-nutrient composition, micro-nutrient composition, and other dietary attributes derived from order information or external data.

The term “activity plan information” refers to information specifying planned or recommended actions in a movement support or travel support scenario, including destinations, schedules, routes, accommodations, and activity descriptions.

The term “information recommendation processing” refers to processing in which candidate information items are selected, ranked, or generated based on condition information, user input, and context, and in which recommendation target information and associated reasons are produced for presentation to the user.

The term “recommendation target information” refers to information identifying one or more items, services, locations, or content pieces that are recommended to a user as a result of information recommendation processing.

In an embodiment, a server, a terminal, and a user cooperate to implement the claimed system. The server includes at least one processor, a main memory, a non-volatile storage device, and a network interface. The terminal includes a processor, a memory, a display unit, an input unit, an audio input/output unit as needed, and a communication interface. The user operates the terminal to provide natural language inputs and to view response information.

The server executes a server program stored in the non-volatile storage device and loaded into the main memory. The server program comprises modules including a session management module, a condition management module, a prompt generation module, a generative AI interface module, a dialog processing module, an emotion analysis interface module, a recommendation module, and a data logging module. The server program is implemented on a general-purpose operating system, for example a UNIX-based operating system, using an application framework such as a web application framework. The server exposes an application programming interface (API) via the network interface using a transfer protocol such as HTTP over TLS.

The terminal executes a client program that presents user interfaces including a dialog screen and an information presentation screen. The terminal communicates with the server via the communication interface over a packet-switched network such as a wireless network or a wired network. The terminal program is implemented as a native application or a browser-based application.

The server acquires user identification information and user situation information from input information transmitted from the terminal. The server stores user identification information, behavior history information, dialog history information, and condition information in a storage device, which is implemented by a database management system such as a relational database management system. The server maintains, in memory, data structures that represent context information. The data structures are implemented, for example, as key-value maps or structured records, and include fields for user identification, current condition information, current emotional state, and dialog state.

The server executes the condition management module to generate and update condition information corresponding to the user situation information. The server generates condition information not only by deterministic application logic but also by using a generative AI model. The generative AI model is implemented as a parameterized neural network trained on natural language corpora, for example a transformer-based language model having multiple self-attention layers, feed-forward layers, and normalization layers. The generative AI model uses fixed model parameters during inference and receives tokenized text as input and generates token sequences as output.

The server executes the prompt generation module to create a prompt sentence that instructs generation of condition information. The server constructs the prompt sentence by embedding structured user situation information into natural language templates and by appending explicit instructions about output format and constraints. The server sends the prompt sentence to the generative AI model via the generative AI interface module. The generative AI interface module converts the prompt sentence into tokens, invokes an inference procedure of the generative AI model, and obtains generated token sequences. The generative AI interface module then decodes the token sequences into text and returns the text to the condition management module.

The server parses the output text into condition information using predetermined parsing rules. The server uses text markers, formatting constraints, or simple delimiting tokens in the prompt sentence so that the output text can be deterministically segmented into fields. This use of structured prompt sentences and parsing rules allows the server to reliably transform unstructured model output into structured condition information, thereby improving the correctness and repeatability of the condition generation process compared with ad hoc natural language use.

The server registers the generated condition information as context information for a dialog processing program. The dialog processing program is implemented, for example, as a dialog management engine that holds a dialog state graph or dialog policies. The server provides the condition information to the dialog processing program via an internal software interface. The server thus enables the dialog processing program to access up-to-date condition information when determining dialog responses.

The terminal acquires natural language inquiry sentences from the user through a keyboard, touchscreen, or voice input followed by speech-to-text conversion. The terminal transmits the natural language inquiry sentences to the server via the network interface. The server executes the dialog processing module to receive the natural language inquiry sentences and to determine corresponding intents and entities. The server may employ a natural language processing library as part of the dialog processing module, which performs tokenization, part-of-speech tagging, and entity recognition. The server then uses the detected intent and entities as features to select appropriate condition information fields from the context information.

The server executes the prompt generation module to create a prompt sentence for answer generation. The server combines the natural language inquiry sentence, the relevant condition information, and dialog state into a single prompt sentence. The server includes explicit instructions within the prompt sentence concerning the role of the generative AI model, the content to be referred to, and the required output style. For example, the server may generate a prompt sentence such as:

“The user is planning a trip to New York from March 1 to March 5 with a mid-range budget. The user asks: ‘What sightseeing spots do you recommend in New York?’ Based on the travel conditions above, provide several recommended sightseeing spots with brief explanations in a friendly tone.”

The server sends this prompt sentence to the generative AI model via the generative AI interface module. The generative AI model executes numerical operations determined by its neural network architecture, including matrix multiplications between learned weight matrices and token embeddings, non-linear activation operations, and attention computations that weight different tokens according to learned attention scores. As a result, the generative AI model generates response information as output text. The server returns the text to the dialog processing module, which may perform additional formatting or content filtering.

The server executes the emotion analysis interface module to identify an emotional state of the user. The server provides the natural language inquiry sentence, or a sequence of several recent sentences, to an emotion analysis program. The emotion analysis program is implemented, for example, as a neural network classifier that receives sequence representations and outputs probability values for multiple emotion categories. The emotion analysis interface module converts the probability vector into a discrete emotional state by selecting the category with the highest probability, optionally subject to a threshold. The server stores the emotional state as part of the context information.

The server executes the prompt generation module again to create a prompt sentence for adjustment of response information according to the emotional state. The server combines the emotional state, the unadjusted response information, and additional instructions into a new prompt sentence. For example, the server may generate a prompt sentence such as:

“The following draft answer will be presented to a user who is frustrated: ‘We found several hotels in your destination city.’ Rewrite this answer in a polite and empathetic tone, explicitly apologizing for the inconvenience and providing reassurance.”

By using the emotional state and explicit instructions, the prompt generation module ensures that the generative AI model modifies content or expression style in a controlled manner. The generative AI model then performs a sequence-to-sequence transformation, re-generating the answer text. The server uses the adjusted response information as the final output to the user. This architecture differs from simple template selection because the adjustment is guided by structured emotion-related instructions, which are fed directly into the generative AI model.

The server executes the recommendation module when the system is used for information recommendation. The server takes as input condition information, such as the user's interests, consumption history, or previous evaluation of items. The server constructs a prompt sentence that instructs the generative AI model to generate candidate recommendation targets and corresponding reasons. For example, the server may generate a prompt sentence such as:

“The user usually enjoys calm music and slow-paced movies and wants to relax today. Recommend several music tracks and films that help the user relax, and provide a short explanation for each recommendation.”

The generative AI model produces a textual list of recommendation target information and explanation sentences. The server maps natural language item names to internal item identifiers using lookup tables or similarity search over embedding vectors. The server then stores the item identifiers as recommendation target information and transmits both identifiers and explanations to the terminal for display. The terminal presents user-selectable elements representing the recommended items and explanation text to assist the user in making selections.

The server accumulates user behavior history information and dialog history information in the storage device. The server periodically or conditionally executes a batch process to update condition information based on the accumulated information. The server constructs another prompt sentence that summarizes recent behavior patterns and instructs the generative AI model to modify the user's preferences or long-term condition information. In one example, the server may generate a prompt sentence such as:

“Based on the following recent queries and bookings by the user, update the user's preferred travel style and suggest updated travel conditions, including typical budget range and preferred destinations: [summary of logs].”

The generative AI model outputs updated condition information, which the server parses and writes into persistent storage. The server thus uses the generative AI model not only for direct answer generation but also as a dynamic component in a condition generation pipeline, thereby reducing the need for complex, hand-coded rule sets.

This architecture produces a technical effect on computer operation. Because the server maintains condition information and context information in structured data structures and uses them to construct targeted prompt sentences, the server avoids reconstructing context from scratch for each new user input. As a result, the server reduces the number of database accesses and the amount of intermediate data generated per interaction, improving processing speed and decreasing memory usage. In addition, by centralizing prompt generation logic in a dedicated module, the server limits the size of the input context provided to the generative AI model, thereby reducing computation time during model inference and network bandwidth for model communication.

The use of emotion analysis and context-aware prompt sentences also improves the precision and stability of responses compared with systems that leave emotion handling entirely inside an opaque model. By explicitly encoding emotion categories and explicit instructions in prompt sentences, the server allows the generative AI model to perform controlled transformations, which decreases the variance of generated answers and reduces the frequency of outputs that are inconsistent with the detected emotional state. This configuration yields a more predictable mapping between input conditions and generated outputs, which is a technical improvement in the functioning of the dialog processing program.

The generative AI model employed in this embodiment is trained in advance using a supervised or unsupervised learning algorithm. The model comprises multiple layers of self-attention blocks, feed-forward blocks, and residual connections. During training, the model parameters are updated using a gradient-based optimization algorithm such as stochastic gradient descent with adaptive learning rates. A loss function such as cross-entropy loss between predicted token distributions and ground-truth tokens is minimized. Training data may be augmented through operations such as random masking, token shuffling within limited ranges, or paraphrasing, thereby improving the model's robustness to variations in input prompt sentences. The use of such a trained model enables the server to perform complex mappings from structured, instruction-rich prompts to structured or semi-structured outputs without designing explicit rules for each possible context.

This system does not merely automate human decision-making. The server performs operations that are not feasible for a human in real time, such as maintaining large-scale context structures tied to many users, performing rapid neural network inference with hundreds of millions or billions of parameters, and adaptively controlling prompt sentences to satisfy computational resource constraints. The server can dynamically adjust prompt length, cut off low-priority context information, and modify temperature and maximum token parameters for the generative AI model based on network conditions or server load. Such adjustments enable efficient use of processing resources and reduce latency for the terminal.

In one embodiment applied to a food provision service, the server receives from the terminal order information that includes a dish name and quantity. The server uses a domain-specific data structure that maps dishes to nutritional profiles stored in the database. The server generates condition information including nutritional values, such as caloric content and macronutrient composition. The server then constructs a prompt sentence such as:

“The user ordered a large pepperoni pizza that contains approximately 800 kilocalories. The user asks: ‘What is the calorie count of the pizza I ordered?’Answer concisely and clearly.”

The generative AI model returns an answer that incorporates the nutritional values. The server transmits the answer to the terminal, and the terminal displays the result on the dialog screen. By integrating structured nutritional profiles with prompt-driven generation, the server guarantees numerical accuracy provided by the database and uses the generative AI model mainly to format and contextualize the information in natural language.

In another embodiment applied to a travel support service, the server receives from the terminal travel information including destination, dates, and budget. The server creates condition information representing travel conditions by invoking the generative AI model with a prompt sentence such as:

“Based on the following travel details, generate a detailed travel plan and important cautions: destination: Paris; duration: 5 days; budget: medium. Provide a day-by-day plan and safety tips.”

The generative AI model outputs text describing an itinerary. The server parses the generated text into a structured itinerary representation, with fields for day index, location, and activity description. The server stores this structured itinerary in the database for subsequent use. When the user later asks for sightseeing recommendations, the server incorporates the itinerary representation into the prompt sentence, such that recommendations are consistent with the already planned days.

In yet another embodiment, the server uses an emotion analysis program to categorize the user's emotional state as excited, neutral, anxious, or frustrated. The server then modifies answer generation behavior by instructing the generative AI model to emphasize different aspects of information. For example, for an anxious user, the server instructs the model to highlight safety and risk mitigation, while for an excited user, the server instructs the model to emphasize enjoyment and opportunities. This explicit switching of emphasis at the prompt level results in a technical effect: the same base condition information is reused, but different parts are selected and ordered according to programmatically derived rules, improving perceived relevance without recomputing the factual data.

Alternative embodiments are also possible. The server may implement the generative AI model locally, using a specialized hardware accelerator such as a graphics processing unit or a tensor processing unit. The server may also implement the emotion analysis program as a separate neural network model using a recurrent neural network or a transformer encoder trained on emotion-labeled corpora. The condition information may be stored in a non-relational database using document-oriented data structures instead of relational tables. The terminal may be a wearable device or an in-vehicle device instead of a smartphone or a personal computer. The architecture of modules and data flows, however, remains centered on the use of structured condition information, explicit prompt sentence generation, and controlled interactions with a generative AI model.

By combining these elements, the system as described provides a concrete implementation that improves the operation of computer-based dialog and recommendation systems, including more efficient context management, reduced redundant computation, enhanced control over generative model behavior through structured prompt sentences, and improved adaptability to user emotion states.

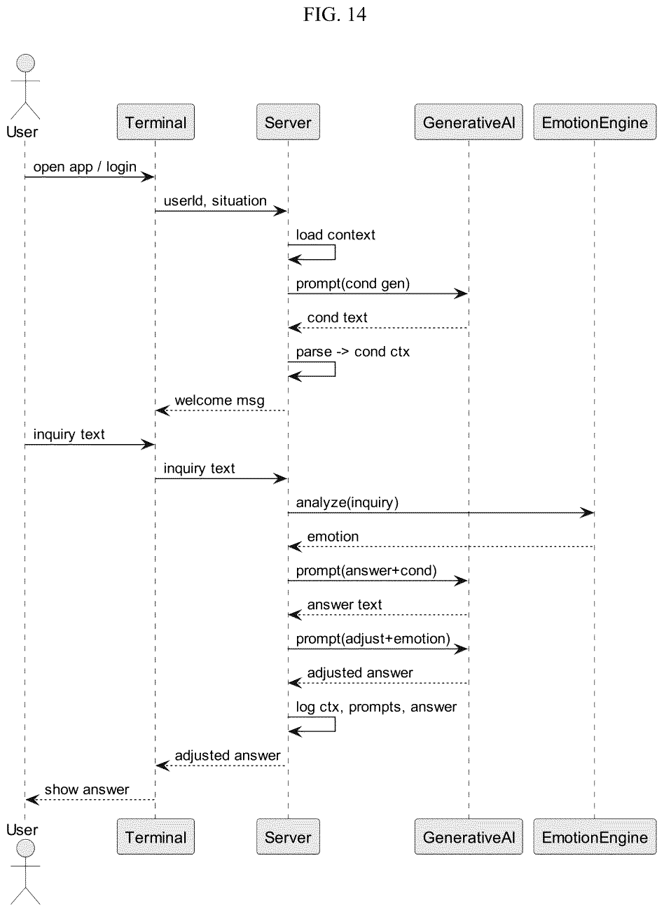

The following describes the processing flow using FIG. 14.

### Step 1

User operates the terminal to launch an application and initiate a session.

Terminal displays a login or identification screen and acquires user inputs such as an identifier, authentication token, or profile selection.

Terminal transmits the acquired user identification information and basic situation information (for example, service domain, language setting, coarse location) to the server as a structured request.

Input: user identification information and basic situation information entered or selected by the user.

Output: a structured request message containing the user identification information and basic situation information.

### Step 2

Server receives the request message via a network interface and validates the user identification information against a user record stored in a storage device.

Server retrieves corresponding user profile data, behavior history information, and dialog history information from a data repository, using the user identification information as a key.

Server stores the retrieved data in an in-memory context structure associated with the current session.

Input: request message containing user identification information and basic situation information.

Output: in-memory context information including user profile data, behavior history information, and dialog history information.

### Step 3

Server acquires initial user situation information from the request and from additional parameters sent by the terminal, such as current domain (food, travel, recommendation), current time, and terminal type.

Server normalizes the user situation information by mapping strings to canonical identifiers, converting time formats, and inferring missing fields using default rules.

Server stores the normalized user situation information in the context information as initial condition seeds.

Input: raw user situation information and profile-related parameters.

Output: normalized user situation information suitable for further condition generation.

### Step 4

Server executes a condition management module to create a first prompt sentence that instructs generation of condition information corresponding to the normalized user situation information.

Server constructs the first prompt sentence by embedding the normalized user situation information into a natural language template and appending instructions on required output structure.

Server sends the first prompt sentence to a generative AI model via a generative AI interface module.

Input: normalized user situation information and prompt template rules.

Output: first prompt sentence transmitted to the generative AI model.

### Step 5

Server causes the generative AI model to perform inference using the first prompt sentence as input.

Server receives generated text from the generative AI model, the generated text describing candidate condition information such as travel conditions, order-related conditions, or interest conditions.

Server parses the generated text using pattern-based rules or delimiters specified in the prompt sentence to extract structured condition fields.

Input: first prompt sentence and model parameters of the generative AI model.

Output: structured condition information derived from the model output text.

### Step 6

Server registers the structured condition information as context information for a dialog processing program.

Server updates a dialog context structure with fields such as destination, dates, budget, order items, or preference categories, and stores this updated context structure in memory and optionally in persistent storage.

Server associates the updated context information with the current session identifier.

Input: structured condition information extracted from the generative AI model output.

Output: updated dialog context information including condition information.

### Step 7

Terminal presents a dialog interface to the user based on an initial message received from the server, which may reference the condition information (for example, “You are planning a trip to New York from March 1 to March 5.”).

User inputs a natural language inquiry sentence through the dialog interface, such as a question about sightseeing, nutrition, or recommended content.

Terminal packages the natural language inquiry sentence with session identifiers and transmits it to the server.

Input: user-entered natural language inquiry sentence.

Output: request message containing the natural language inquiry sentence and session identifiers.

### Step 8

Server receives the natural language inquiry sentence and passes it to a dialog processing module.

Server executes natural language processing to tokenize the inquiry, recognize named entities, and infer an intent label.

Server identifies which condition information fields in the context information are relevant to the detected intent (for example, travel conditions for sightseeing questions or order conditions for nutrition questions).

Input: natural language inquiry sentence and current dialog context information.

Output: detected intent, extracted entities, and selected condition information fields.

### Step 9

Server sends the natural language inquiry sentence to an emotion analysis program and requests classification of the user's emotional state.

Server receives emotion probabilities or scores from the emotion analysis program and selects a dominant emotional state, such as “excited,” “anxious,” or “frustrated,” based on threshold and maximum score criteria.

Server stores the selected emotional state in the context information as current emotion data.

Input: natural language inquiry sentence.

Output: discrete emotional state associated with the user.

### Step 10

Server constructs a second prompt sentence for answer generation by combining the natural language inquiry sentence, the relevant condition information, the dialog context, and general instructions for the generative AI model.

Server includes in the second prompt sentence explicit text describing the user situation and specifying the required answer style (for example, concise or detailed).

Server transmits the second prompt sentence to the generative AI model via the generative AI interface module.

Input: natural language inquiry sentence, selected condition information, and dialog context information.

Output: second prompt sentence provided to the generative AI model.

### Step 11

Server causes the generative AI model to execute an inference procedure based on the second prompt sentence, performing internal numerical operations such as token embedding, attention weight computation, and layer-wise transformations.

Server receives an initial answer text from the generative AI model as response information.

Server attaches metadata such as intent label and referenced condition fields to the initial answer text for later processing.

Input: second prompt sentence and current model parameters.

Output: response information in the form of initial answer text.

### Step 12

Server generates a third prompt sentence that instructs adjustment of the initial answer text according to the emotional state stored in the context information.

Server embeds the emotional state and the initial answer text into a text instruction, for example by specifying “the user is anxious” or “the user is frustrated” and including directives such as “use a reassuring tone” or “apologize and provide clear guidance.”

Server transmits the third prompt sentence and the initial answer text to the generative AI model via the generative AI interface module.

Input: emotional state, initial answer text, and adjustment rules.

Output: third prompt sentence containing explicit instructions for adjustment.

### Step 13

Server causes the generative AI model to perform a transformation based on the third prompt sentence and the initial answer text.

Server receives adjusted response information as modified answer text from the generative AI model, the modified answer text reflecting changes in tone, emphasis, and structure that correspond to the specified emotional state.

Server verifies that the adjusted response information still contains required factual elements, for example by checking that key numeric values or item names are preserved.

Input: third prompt sentence and initial answer text.

Output: adjusted response information suitable for presentation to the user.

### Step 14

Server sends the adjusted response information to the terminal in a structured response message containing the answer text, emotion tag, and optional presentation hints such as emphasis markers or list structure.

Terminal receives the structured response message and renders the answer text within the dialog interface, applying presentation hints to format the content.

User views the displayed answer and may optionally provide further input to continue the dialog.

Input: adjusted response information and presentation hints.

Output: displayed answer on the terminal screen.

### Step 15

Server logs the natural language inquiry sentence, the second and third prompt sentences, the initial and adjusted response information, the detected intent, and the emotional state in the storage device.

Server appends this log entry to behavior history information and dialog history information associated with the user identification information and the session identifier.

Server may compress or summarize certain elements of the logs for efficient storage, for example by storing hash values of repeated text segments or by maintaining aggregate counters.

Input: interaction data including all related prompts, responses, and context.

Output: updated behavior history information and dialog history information in persistent storage.

### Step 16

Server periodically or upon a trigger event constructs a fourth prompt sentence that summarizes recent behavior history information and dialog history information for a user.

Server includes in the fourth prompt sentence a description of observed patterns, such as frequently requested locations, budget ranges, or types of content, and instructs the generative AI model to update long-term condition information such as user preferences or default travel conditions.

Server sends the fourth prompt sentence to the generative AI model and receives updated condition information as structured or semi-structured text.

Input: aggregated behavior history information and dialog history information.

Output: fourth prompt sentence and updated condition information generated by the generative AI model.

### Step 17

Server parses the updated condition information into structured fields using predetermined parsing rules and merges these fields into the existing context information and user profile records.

Server writes the updated condition information to the storage device so that subsequent sessions or interactions can utilize the refined conditions without recomputing them from scratch.

Server thereby improves future processing efficiency and personalization accuracy by reusing the updated condition information during subsequent prompt generation steps.

Input: updated condition information text from the generative AI model.

Output: persisted, structured updated condition information integrated into the user profile and context information.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

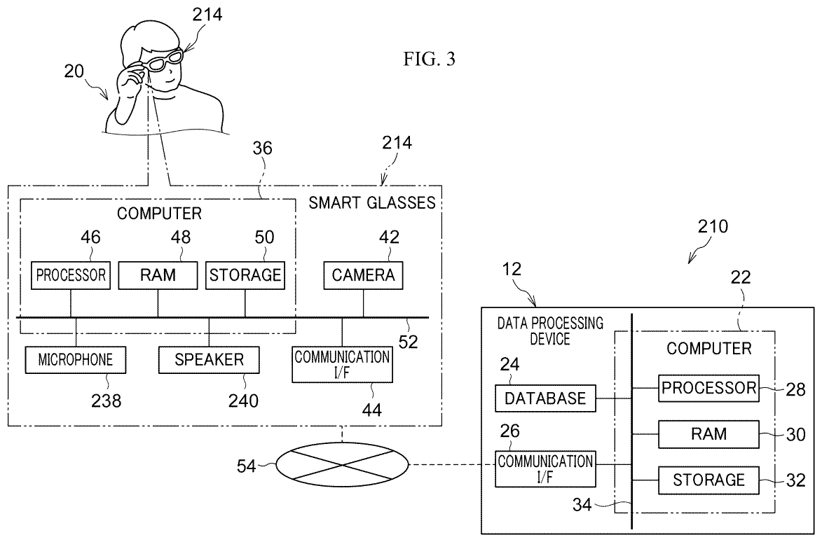

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

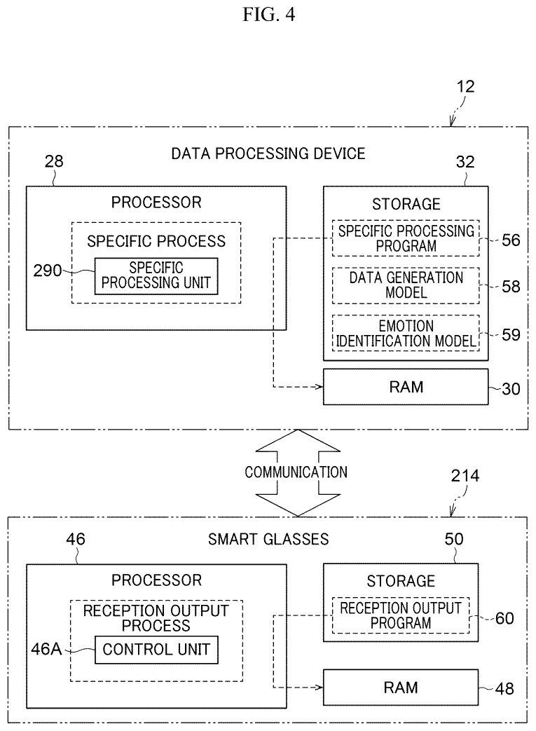

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

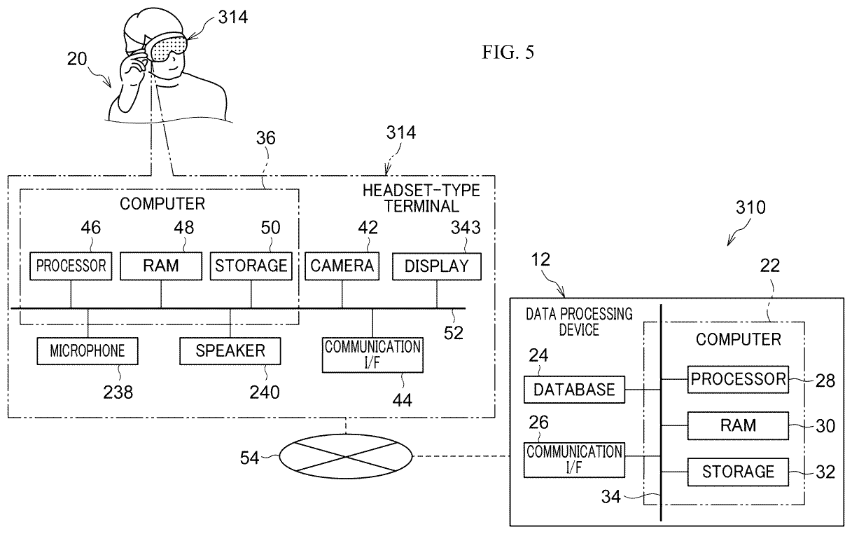

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

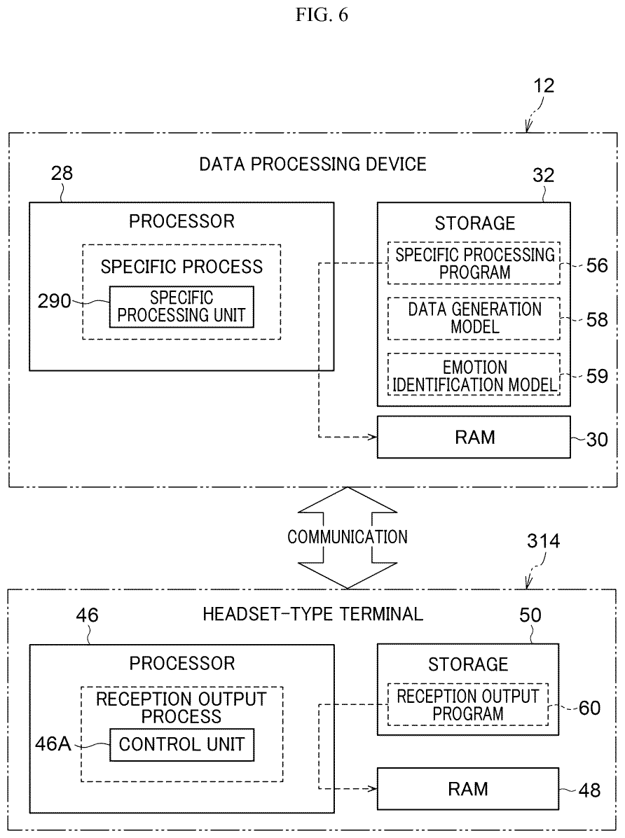

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

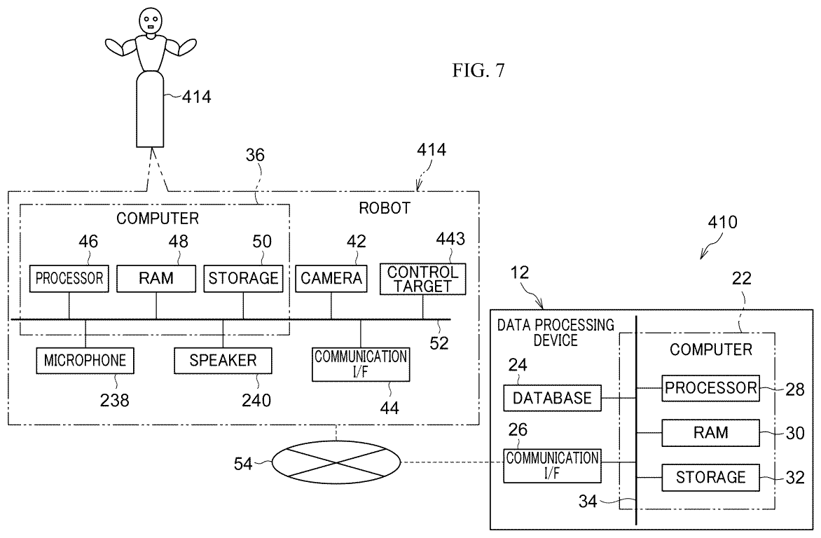

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

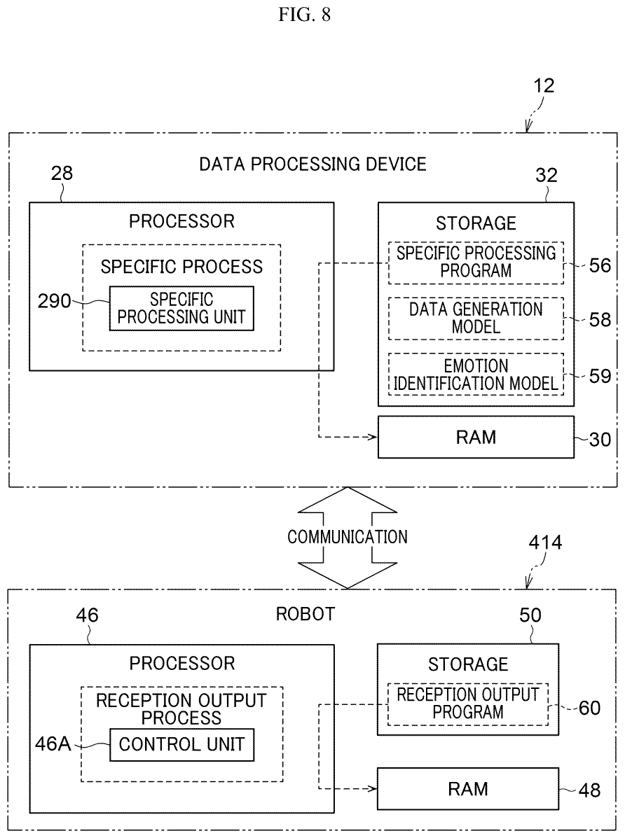

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

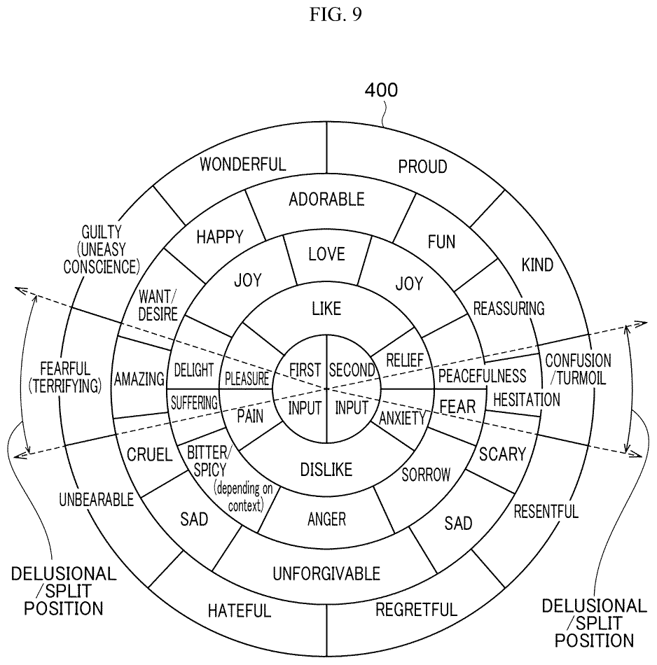

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

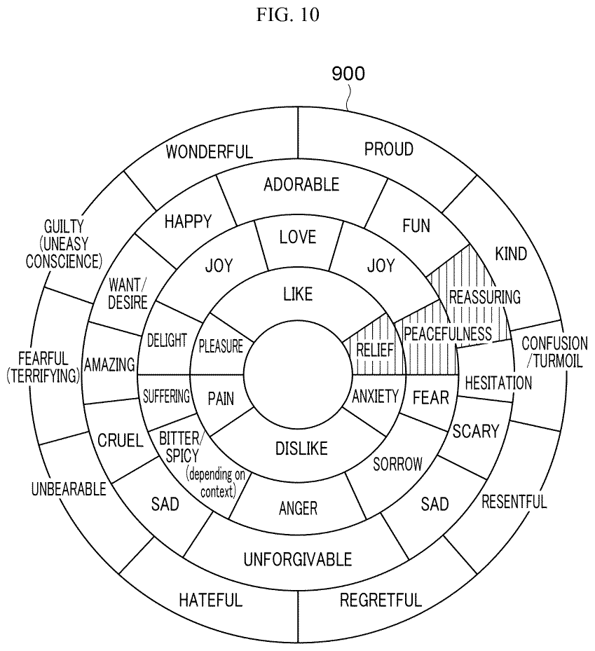

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor and a storage device,
wherein the processor is configured to
acquire identification information and travel information of a user, store the travel information in the storage device in association with the identification information, and
generate structured information representing travel conditions on the basis of destination information, schedule information, and accommodation information included in the travel information,
generate, using the structured information as input, a condition sentence that describes contents of the structured information in natural language and a prompt sentence that instructs a generative information processing apparatus to generate the travel conditions on the basis of the condition sentence, input the prompt sentence into the generative information processing apparatus to automatically supplement or update the travel conditions, and generate condition information including the supplemented or updated travel conditions,
generate, using the condition information as input, context information that describes the condition information in natural language and a prompt sentence that instructs an interactive information processing apparatus to perform conversation processing on the basis of the context information, and input the condition information together with the prompt sentence into the interactive information processing apparatus so as to start a dialog with the user, and
acquire inquiry information transmitted from a user terminal, associate the inquiry information with the condition information, transmit the inquiry information and the condition information to the interactive information processing apparatus, and perform response control for outputting response information, which is acquired from the interactive information processing apparatus, to the user terminal.

### Supplementary 2

The system according to Supplementary 1,
wherein the processor is configured to
generate, on the basis of inquiry history information of the user and the condition information, a prompt sentence that instructs the generative information processing apparatus to generate additional travel conditions for updating the condition information and to generate a response candidate sentence reflecting the additional travel conditions, input the prompt sentence into the generative information processing apparatus to update the condition information, and
provide updated condition information to the interactive information processing apparatus.

### Supplementary 3

The system according to Supplementary 1,
wherein the processor is configured to
acquire, from the storage device, the travel information and the condition information for each user, generate a prompt sentence that instructs the generative information processing apparatus to perform optimization processing for automatically adjusting contents of condition generation processing for generating the condition information and formats and control parameters of prompt sentences to be input into the generative information processing apparatus and the interactive information processing apparatus on the basis of the condition information and the inquiry history information, and input the prompt sentence into the generative information processing apparatus to cause the optimization processing to be performed.

### Application Example 1

### Supplementary 1

A system comprising a processor,
wherein the processor is configured to
acquire user identification information and travel-related information, and create a prompt sentence that instructs a generative AI model to generate travel condition data based on user attribute information, movement schedule information, stay information, and preference information included in the acquired information, and input the prompt sentence into the generative AI model so that the travel condition data is automatically generated,
analyze context information including the generated travel condition data and inquiry text acquired from a user, by creating a prompt sentence that instructs an external processing apparatus having a natural language processing function or the generative AI model to extract inquiry intent information and related item information, and input the prompt sentence into the external processing apparatus or the generative AI model so that the inquiry intent information and the related item information are extracted,
generate search condition data for acquiring destination-related information from an external information source, based on the extracted inquiry intent information, the related item information, and the travel condition data, and acquire external information data including facility information, weather information, and event information from an external information providing apparatus by using the search condition data,
execute processing for selection and evaluation of candidate information data to be presented to the user, based on the acquired external information data and the travel condition data, by creating a prompt sentence that instructs the generative AI model to generate response text data including a natural language description text and a recommendation reason text corresponding to the candidate information data, and inputting the prompt sentence and the candidate information data into the generative AI model so that the response text data is generated,
transmit the generated response text data and the candidate information data to a terminal apparatus via a communication apparatus, and cause the terminal apparatus to display the response text data so as to start or continue dialog processing with the user, and
record operation information of the user and selection results for the response text data as log data, and create a prompt sentence that instructs the generative AI model to dynamically update the travel condition data and recommendation policy data, based on the log data and the travel condition data, and input the prompt sentence into the generative AI model so that a condition generation process and an information selection process are updated.

### Supplementary 2

The system according to supplementary 1,
wherein the processor is configured to
summarize context information including user inquiry text, the travel condition data, and the acquired external information data, generate a prompt sentence that specifies types of information items to be presented to the user, a presentation order, and a representation format based on the summarized context information, and input the prompt sentence into the generative AI model so that personalized natural language response data is generated for each user, and to repeatedly execute this processing for each step of the dialog.

### Supplementary 3

The System According to Supplementary 1,
wherein the processor is configured to
store the user identification information, the travel condition data, the acquired external information data, the prompt sentences to the generative AI model, and the response text data from the generative AI model as history data in a storage apparatus, create a prompt sentence that instructs the generative AI model to apply a condition generation algorithm and a recommendation algorithm to the history data, and input the prompt sentence into the generative AI model so that updated travel condition data, weighting parameters, and information selection rules for use in future dialog processing are automatically generated.

### Example 2

### Supplementary 1

A system comprising a processor,
wherein the processor is configured to
acquire user identification information and movement information, generate structured information including conditions related to movement for each user, and store the structured information in a storage area,
construct a prompt sentence including instruction content for automatically generating or updating the conditions related to movement, based on the structured information and input information from the user, and input the prompt sentence to a generative AI model so that the generative AI model updates the conditions related to movement,
attach the updated conditions related to movement as context information to a dialogue processing apparatus having a natural language processing function, transmit the context information to the dialogue processing apparatus, and cause the dialogue processing apparatus to start and maintain a dialogue session with the user based on the conditions related to movement,
construct a prompt sentence for instructing generation of response content to the user by including a dialogue text transmitted from a user terminal, the conditions related to movement, and regional information or cultural information acquired from an external information source, and input the prompt sentence to the generative AI model so that the generative AI model generates a response text in natural language, and
transmit the generated response text to the user terminal in association with a dialogue history and the conditions related to movement.

### Supplementary 2

The system according to supplementary 1,
wherein the processor is configured to
execute processing for extracting preferences or constraints common to a plurality of dialogues of the user, based on the conditions related to movement stored in the storage area and the dialogue history acquired from the dialogue processing apparatus, dynamically update the prompt sentence by including the extracted preferences or constraints, and cause the generative AI model to gradually generate a personalized response text for each user.

### Supplementary 3

The system according to supplementary 1,
wherein the processor is configured to
select business information or sightseeing information relating to a target region from an external information providing apparatus in association with the conditions related to movement, and input to the generative AI model a prompt sentence including a selection result as prior knowledge so that the generative AI model generates a response text that takes into account attributes of the target region.

### Application Example 2

### Supplementary 1

A system comprising a processor,
wherein the processor is configured to
acquire user identification information and user situation information from input information, and create a prompt sentence that instructs generation of condition information corresponding to the user situation information,
input the prompt sentence into a generative AI model, cause the generative AI model to automatically generate the condition information, and provide the generated condition information to a dialog processing program and register the condition information as context information for dialog processing,
acquire a natural language inquiry sentence from a user terminal, analyze the inquiry sentence, create a prompt sentence for performing answer generation based on the condition information and the context information, and input the prompt sentence into the generative AI model to cause the generative AI model to generate response information,
input the inquiry sentence into an emotion analysis program, identify an emotional state of the user, create a prompt sentence that instructs adjustment of content or expression style of the response information according to the identified emotional state, and input the prompt sentence into the generative AI model to cause the generative AI model to generate adjusted response information,
transmit the adjusted response information to the user terminal, and cause the user terminal to display the adjusted response information as a dialog screen or an information presentation screen, and
accumulate user behavior history information and dialog history information in a storage device, create a prompt sentence that instructs updating of the condition information based on the accumulated information, input the prompt sentence into the generative AI model to cause the generative AI model to generate updated condition information, and update the context information using the updated condition information.

### Supplementary 2

The system according to supplementary 1,
wherein the processor is configured to
cause the condition information to include a plurality of types of condition information including nutrition information based on order information in a food provision service and activity plan information based on movement support service information, and create a prompt sentence that instructs switching or emphasizing presentation content of the nutrition information or the activity plan information according to the emotional state of the user, and
input the prompt sentence into the generative AI model.

### Supplementary 3

The system according to supplementary 1,
wherein the processor is configured to
create a prompt sentence for executing information recommendation processing using the natural language inquiry sentence acquired from the user terminal and the condition information, input the prompt sentence into the generative AI model to cause the generative AI model to generate recommendation response information including recommendation target information and a presentation reason for the recommendation target information, and further create a prompt sentence that instructs adjustment of a presentation order or expression style of the recommendation response information according to the emotional state, and input the prompt sentence into the generative AI model.

What is claimed is:

1. A system comprising:
circuitry configured to:
receive, via a communication interface coupled to a packet-switched network, attribute data and event data associated with a terminal device;
store the attribute data and the event data in a storage device and generate structured condition data on the basis of temporal parameters, location parameters, and facility parameters included in the event data;
construct a first prompt data structure including a condition sentence derived from the structured condition data and an instruction sequence directing a generative neural network model to supplement or update the structured condition data, and transmit the first prompt data structure to the generative neural network model to obtain updated condition data;
construct a second prompt data structure including context data derived from the updated condition data and an instruction sequence directing an interactive information processing apparatus to perform dialog processing on the basis of the context data; and
transmit, via the packet-switched network, response data generated by the interactive information processing apparatus to the terminal device.

2. The system according to claim 1, wherein the circuitry generates the structured condition data by filtering item records stored in the storage device on the basis of the location parameters, computing a duration value from the temporal parameters, calculating a distance or a transit time between a facility indicated by the facility parameters and each filtered item record, and ranking the filtered item records on the basis of a scoring function that receives the distance or the transit time as input.

3. The system according to claim 2, wherein the circuitry derives the condition sentence by applying a template-based text generation operation that replaces placeholder tokens in a natural language template with values extracted from fields of the structured condition data, the fields including at least a destination field, a duration field, a facility field, and a ranked item list field.

4. The system according to claim 3, wherein the event data represents travel reservation information of a user, the location parameters include a destination region and accommodation coordinates, the temporal parameters include a check-in date and a check-out date, and the facility parameters include a lodging facility name and a lodging category.

5. The system according to claim 4, wherein the ranked item list field includes recommended points of interest ranked by the scoring function, and the circuitry constructs the first prompt data structure to instruct the generative neural network model to supplement the structured condition data with additional points of interest, estimated visit durations, and suggested visit sequences on the basis of the condition sentence.

6. The system according to claim 1, wherein the generative neural network model comprises a transformer architecture including a token embedding layer, a positional encoding mechanism, a plurality of self-attention layers, and feedforward sublayers, and the circuitry specifies, within the first prompt data structure, at least one of a maximum output length parameter, a sampling temperature parameter, and a role instruction that constrains output of the generative neural network model.

7. The system according to claim 6, wherein the circuitry parses output data received from the generative neural network model by applying a structured format extraction operation that identifies field delimiters in the output data and converts identified fields into records of the updated condition data stored in the storage device.

8. The system according to claim 7, wherein the circuitry merges the records of the updated condition data with existing records of the structured condition data in the storage device by matching key fields and replacing or appending values, and generates the context data by converting the merged records into a natural language description using the template-based text generation operation.

9. The system according to claim 1, wherein the circuitry further receives inquiry data from the terminal device via the packet-switched network, inputs the inquiry data to an emotion analysis model, and obtains emotion data indicating an emotional state associated with the inquiry data.

10. The system according to claim 9, wherein the circuitry constructs a third prompt data structure including the inquiry data, the updated condition data, and an instruction sequence directing the generative neural network model to generate the response data, and adjusts at least one of a content scope and an expression style of the instruction sequence on the basis of the emotion data.

11. The system according to claim 10, wherein, when the emotion data indicates at least one of confusion and anxiety, the circuitry modifies the instruction sequence to direct the generative neural network model to reduce a complexity level and increase a detail level of the response data, and when the emotion data indicates satisfaction, the circuitry modifies the instruction sequence to direct the generative neural network model to include additional suggestion items in the response data.

12. The system according to claim 1, wherein the circuitry generates search condition data on the basis of the updated condition data and inquiry data received from the terminal device, transmits the search condition data to an external information providing apparatus via the packet-switched network, and receives external information data from the external information providing apparatus.

13. The system according to claim 12, wherein the external information data includes at least one of facility attribute data, meteorological data, and event schedule data associated with the location parameters, and the circuitry incorporates the external information data into the second prompt data structure as supplemental context for the dialog processing.

14. The system according to claim 13, wherein the circuitry selects candidate items from the external information data by applying a relevance scoring operation that computes a score for each candidate item on the basis of the updated condition data and preference data derived from the attribute data, and constructs the second prompt data structure to include the selected candidate items together with a recommendation reason generated by the generative neural network model for each selected candidate item.

15. The system according to claim 1, wherein the circuitry stores, in the storage device, dialog history data associating successive inquiry data and response data with the updated condition data, and constructs a fourth prompt data structure including the dialog history data and an instruction sequence directing the generative neural network model to update the structured condition data on the basis of behavioral patterns identified in the dialog history data.

16. The system according to claim 15, wherein the circuitry further stores selection result data indicating items selected or rejected by a user of the terminal device, and modifies a recommendation policy stored in the storage device on the basis of the selection result data, the modified recommendation policy being incorporated into subsequent prompt data structures to bias the generative neural network model toward preferred item categories.

17. The system according to claim 1, wherein the circuitry maintains a dialog session state in the storage device that accumulates context data across successive exchanges with the terminal device, and appends each successive inquiry data and corresponding response data to the dialog session state, and provides the accumulated dialog session state as input to the interactive information processing apparatus for each subsequent dialog processing operation.

18. A system comprising:
circuitry configured to:
receive, via a communication interface coupled to a packet-switched network, attribute data and event data from a terminal device, and store the attribute data and the event data in a storage device;
generate structured condition data by filtering item records on the basis of location parameters included in the event data, computing a duration value from temporal parameters included in the event data, and ranking filtered item records using a scoring function that receives a distance value between a facility indicated by facility parameters and each filtered item record;
derive a condition sentence from the structured condition data using a template-based text generation operation, construct a first prompt data structure including the condition sentence and an instruction sequence, and transmit the first prompt data structure to a generative neural network model comprising a transformer architecture with a token embedding layer, a positional encoding mechanism, a plurality of self-attention layers, and feedforward sublayers to obtain updated condition data;
construct a second prompt data structure including context data derived from the updated condition data and an instruction sequence directing an interactive information processing apparatus to perform dialog processing;
receive inquiry data from the terminal device, input the inquiry data to an emotion analysis model to obtain emotion data indicating an emotional state, and construct a third prompt data structure including the inquiry data, the updated condition data, and an instruction sequence adjusted on the basis of the emotion data directing the generative neural network model to generate response data;
generate search condition data on the basis of the updated condition data and the inquiry data, transmit the search condition data to an external information providing apparatus, receive external information data, and incorporate the external information data into the response data; and
transmit the response data to the terminal device via the packet-switched network, and store dialog history data associating the inquiry data, the response data, and the updated condition data in the storage device.

19. The system according to claim 18, wherein the circuitry constructs a fourth prompt data structure including the dialog history data and an instruction sequence directing the generative neural network model to update the structured condition data on the basis of behavioral patterns identified in the dialog history data, and modifies a recommendation policy stored in the storage device on the basis of selection result data indicating items selected or rejected via the terminal device.

20. A method performed by circuitry of a server coupled to a packet-switched network via a communication interface, the method comprising:
receiving, via the communication interface, attribute data and event data associated with a terminal device;
storing the attribute data and the event data in a storage device and generating structured condition data on the basis of temporal parameters, location parameters, and facility parameters included in the event data;
constructing a first prompt data structure including a condition sentence derived from the structured condition data and an instruction sequence directing a generative neural network model to supplement or update the structured condition data, and transmitting the first prompt data structure to the generative neural network model to obtain updated condition data;
constructing a second prompt data structure including context data derived from the updated condition data and an instruction sequence directing an interactive information processing apparatus to perform dialog processing on the basis of the context data; and
transmitting, via the packet-switched network, response data generated by the interactive information processing apparatus to the terminal device.
